(19) United States
(12) Patent Application Publication
(10) Pub. No.: US 2026/0133477 A1
(43) Pub. Date: May 14, 2026

(54) WAVELENGTH CONVERTING APPARATUS, LIGHT SOURCE APPARATUS, AND PROJECTOR

(71) Applicant: SEIKO EPSON CORPORATION, Tokyo (JP)

(72) Inventors: Norikazu KADOTANI, AZUMINO-SHI (JP); Masamitsu HOSODA, SAKAI-SHI (JP)

(21) Appl. No.: 19/385,722

(22) Filed: Nov. 11, 2025

(30) Foreign Application Priority Data
Nov. 12, 2024 (JP) 2024-197681

(51) Int. Cl. G03B 21/20; G03B 21/16

(52) U.S. Cl. CPC G03B 21/204; G03B 21/16; G03B 21/2066

(57) ABSTRACT

A wavelength converting apparatus includes a base having a first surface; a rotator configured to rotate the base; a wavelength converter disposed at a side facing the first surface of the base and configured to convert incident first light having a first wavelength band into second light having a second wavelength band different from the first wavelength band; and a phase changing medium to which heat of the wavelength converter is transmitted. The base has a recess provided at the first surface of the base at a position corresponding to the wavelength converter. The phase changing medium is encapsulated in the recess, and a phase state of the phase changing medium is a liquid-solid two-phase state at least during a period for which the first light is incident on the wavelength converter.

The present application is based on, and claims priority from JP Application Serial Number 2024-197681, filed Nov. 12, 2024, the disclosure of which is hereby incorporated by reference herein in its entirety.

### BACKGROUND

### 1. Technical Field

The present disclosure relates to a wavelength converting apparatus, a light source apparatus, and a projector.

### 2. Related Art

There is a wavelength converting apparatus of related art that converts the wavelength of incident light and outputs the light having the converted wavelength (refer, for example, to JP-A-2016-066061 and JP-A-2017-207673).

The wavelength converting apparatus described in JP-A-2016-066061 is a phosphor wheel apparatus including a phosphor wheel, a motor, and a fan member. The phosphor wheel rotated by the motor includes a disk-shaped substrate and a phosphor disposed at one surface of the substrate along a circumferential direction of the substrate. The fan member is a stainless steel plate attached to the other surface of the substrate and includes multiple blades. The multiple blades are each formed by bending the stainless steel plate. When the phosphor wheel is rotated, the multiple blades generate an airflow, and the generated airflow cools the phosphor heated by incident excitation light and the substrate to which the heat of the phosphor is transmitted.

The wavelength converting apparatus described in JP-A-2017-207673 is a fluorescence generator including a fluorescent film, a disk-shaped chamber vapor that encapsulates a working fluid therein, and a stepper motor. The vapor chamber is rotatable by the motor, and the fluorescent film is formed in an annular shape at one surface of the vapor chamber. When laser light is incident on the fluorescent film and the fluorescent film generates heat, the vapor chamber transmits the heat transmitted from the fluorescent film to the other surface of the vapor chamber via the working fluid, and dissipates the heat via a heat dissipater located at the other surface. Furthermore, the rotation of the vapor chamber causes both capillary force and centrifugal force to act on the working fluid condensed in the heat dissipater of the vapor chamber. The condensed working fluid can therefore be readily moved to the inner surface of the vapor chamber that is a surface corresponding to the fluorescent film provided at a portion facing the circumferential edge of the vapor chamber, so that the heat transfer efficiency is increased.

JP-A-2016-066061 and JP-A-2017-207673 are examples of the related art.

In the wavelength converting apparatus described in JP-A-2016-066061, the phosphor and the substrate are cooled by causing the airflow generated by the fan member that rotates together with the substrate to flow. However, since the phosphor and the substrate are cooled only by the airflow, the phosphor and the substrate may not be sufficiently cooled. There is therefore a problem of a tendency of a decrease in the light use efficiency of the phosphor.

In the wavelength converting apparatus described in JP-A-2017-207673, although the heat of the fluorescent film can be quickly diffused and transferred by the vapor chamber, there is a problem of a difficulty maintaining the temperature of the fluorescent film within a temperature range over which the light use efficiency of the fluorescent film is sufficiently high.

A configuration capable of readily maintaining the temperature of the phosphor has therefore been demanded.

### SUMMARY

A wavelength converting apparatus according to a first aspect of the present disclosure includes: a base having a first surface; a rotator configured to rotate the base; a wavelength converter disposed at a side facing the first surface of the base and configured to convert incident first light having a first wavelength band into second light having a second wavelength band different from the first wavelength band; and a phase changing medium to which heat of the wavelength converter is transmitted. The base has a recess provided at the first surface of the base at a position corresponding to the wavelength converter. The phase changing medium is encapsulated in the recess, and a phase state of the phase changing medium is a liquid-solid two-phase state at least during a period for which the first light is incident on the wavelength converter.

A light source apparatus according to a second aspect of the present disclosure includes a light source configured to output the first light; and the wavelength converting apparatus according to the first aspect described above on which the first light output from the light source is incident.

A projector according to a third aspect of the present disclosure includes: the light source apparatus according to the second aspect described above; a light modulator configured to modulate light output from the light source apparatus; and a projection optical apparatus configured to project the light modulated by the light modulator.

### BRIEF DESCRIPTION OF THE DRAWINGS

FIG. 1 is a diagrammatic view showing the configuration of a projector in a first embodiment.

FIG. 2 is a diagrammatic view showing the configuration of a light source apparatus in the first embodiment.

FIG. 3 is a perspective view showing a wavelength converting apparatus in the first embodiment.

FIG. 4 is a perspective view showing the wavelength converting apparatus in the first embodiment.

FIG. 5 is an exploded perspective view showing the wavelength converting apparatus in the first embodiment.

FIG. 6 is a front view showing the wavelength converting apparatus in the first embodiment.

FIG. 7 is a cross-sectional view showing a phosphor wheel in the first embodiment.

FIG. 8 is an enlarged plan view of a recess in the first embodiment.

FIG. 9 is a perspective view showing a wavelength converting apparatus provided in a light source apparatus of a projector according to a second embodiment.

FIG. 10 is a perspective view showing the wavelength converting apparatus in the second embodiment.

FIG. 11 is an exploded perspective view showing the wavelength converting apparatus in the second embodiment.

FIG. 12 is an exploded perspective view showing the wavelength converting apparatus in the second embodiment.

FIG. 13 is a cross-sectional view showing a phosphor wheel in the second embodiment.

FIG. 14 is a perspective view showing a wavelength converting apparatus provided in a light source apparatus of a projector according to a third embodiment.

FIG. 15 is a cross-sectional view showing a phosphor wheel in the third embodiment.

FIG. 16 is a plan view showing a wavelength converting apparatus provided in a light source apparatus of a projector in a fourth embodiment.

FIG. 17 shows the positional relationship between a recess and a wavelength converter in the fourth embodiment.

### DESCRIPTION OF EMBODIMENTS

### First Embodiment

A first embodiment of the present disclosure will be described below based on the drawings.

### Schematic Configuration of Projector

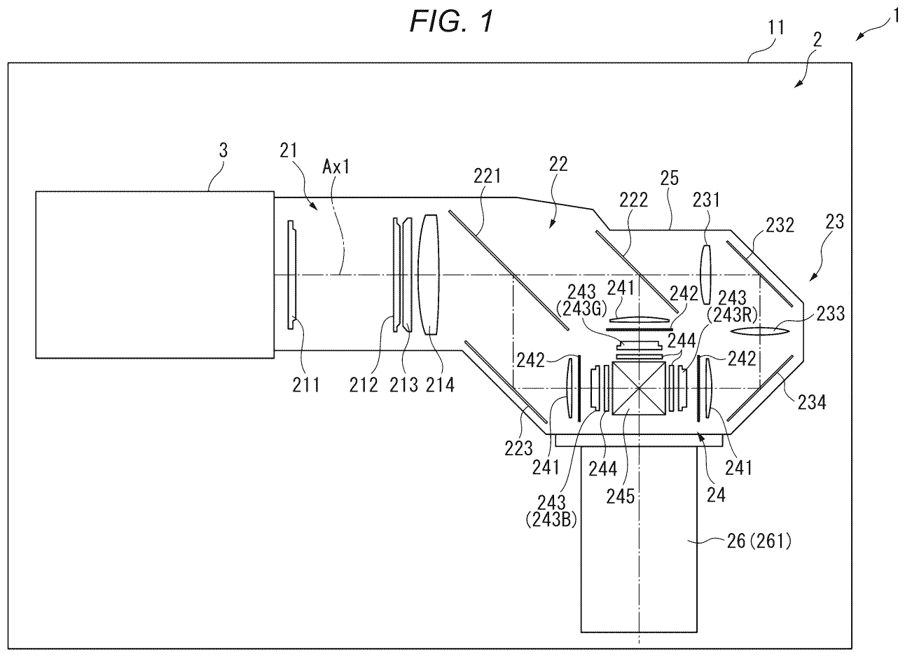

FIG. 1 is a diagrammatic view showing the configuration of a projector 1 according to the present embodiment.

The projector 1 according to the present embodiment projects image light according to image information. The projector 1 includes an exterior enclosure 11 and an image projecting apparatus 2 housed in the exterior enclosure 11, as shown in FIG. 1. In addition to the above, the projector 1 includes, although not shown, a controller that controls the operation of the projector 1, a power supply apparatus that supplies electric power to electronic parts of the projector 1, and a cooling apparatus that cools a cooling target of the projector 1.

### Configuration of Image Projecting Apparatus

The image projecting apparatus 2 forms the image light according to the image information to be input, and projects the formed image light. The image projecting apparatus 2 includes a light source apparatus 3, a homogenizing system 21, a color separation system 22, a relay system 23, an image forming apparatus 24, an optical part enclosure 25, and a projection optical apparatus 26.

The light source apparatus 3 outputs illumination light to the homogenizing system 21. The configuration of the light source apparatus 3 will be described below in detail.

The homogenizing system 21 homogenizes the illumination light output from the light source apparatus 3. The homogenized illumination light travels via the color separation system 22 and the relay system 23 and illuminates a light modulation region of each light modulator 243, which will be described later. The homogenizing system 21 includes two lens arrays 211 and 212, a polarization converter 213, and a superimposing lens 214.

The color separation system 22 separates the illumination light incident from the homogenizing system 21 into multiple kinds of color light, red light, green light, and blue light. The color separation system 22 includes two dichroic mirrors 221 and 222, and a reflection mirror 223, which reflects the blue light separated by the dichroic mirror 221.

The relay system 23 is provided in the optical path of the red light longer than optical paths of the other kinds of color light and suppresses a loss of the red light. The relay system 23 includes a light-incident-side lens 231, a relay lens 233, and reflection mirrors 232 and 234. In the present embodiment, the red light is guided to the relay system 23, but not necessarily. For example, the optical path of the blue light may be configured to be longer than the optical paths of the other kinds of color light, and the blue light may be guided to the relay system 23.

The image forming apparatus 24 modulates the multiple kinds of incident color light, the red light, the green light, and the blue light, and combines the multiple kinds of modulated color light with one another to form the image light. The image forming apparatus 24 includes three field lenses 241, three light-incident-side polarizers 242, three light modulators 243, and three light-exiting-side polarizers 244 provided in accordance with the multiple kinds of incident color light, and one light combining system 245.

The light modulators 243 modulate the light from the light source apparatus 3 to form the image light. Specifically, the light modulators 243 modulate the multiple kinds of color light incident via the light-incident-side polarizers 242 in accordance with image signals and output the multiple kinds of modulated color light. The three light modulators 243 include a light modulator 243R, which modulates the red light, a light modulator 243G, which modulates the green light, and a light modulator 243B, which modulates the blue light. The light modulators 243 can each, for example, be a transmissive liquid crystal panel.

The light combining system 245 combines the three kinds of color light modulated by the light modulators 243R, 243G, and 243B with one another. The image light as a result of the combining operation performed by the light combining system 245 enters the projection optical apparatus 26. In the present embodiment, the light combining system 245 is configured with a cross dichroic prism having a substantially rectangular parallelepiped shape, and may instead be configured with multiple dichroic mirrors.

The optical part enclosure 25 houses the homogenizing system 21, the color separation system 22, the relay system 23, and the image forming apparatus 24 described above. Note that a theoretical optical axis Ax1 is set in the image projecting apparatus 2, and the optical part enclosure 25 holds the homogenizing system 21, the color separation system 22, the relay system 23, and the image forming apparatus 24 at predetermined positions on the optical axis Ax1. The light source apparatus 3 and the projection optical apparatus 26 are disposed at predetermined positions on the optical axis Ax1.

The projection optical apparatus 26 projects the image light made incident from the image forming apparatus 24 onto a projection receiving surface such as a screen. That is, the projection optical apparatus 26 projects the image light formed by the image forming apparatus 24. The projection optical apparatus 26 can, for example, be an assembled lens including multiple lenses that are not shown and a lens barrel 261, which houses the multiple lenses.

### Configuration of Light Source Apparatus

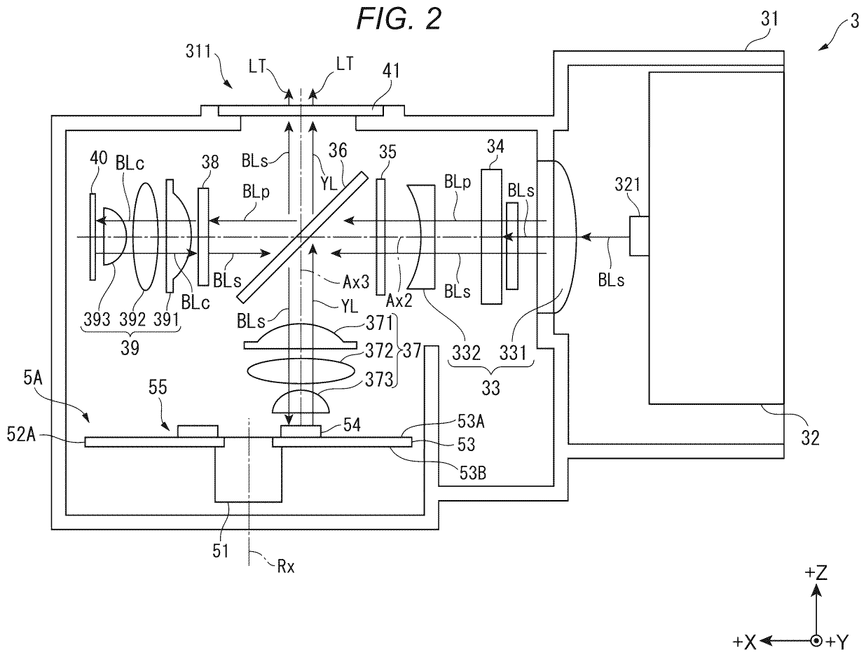

FIG. 2 is a diagrammatic view showing the light source apparatus 3.

The light source apparatus 3 outputs the illumination light, with which the image forming apparatus 24 is illuminated, to the homogenizing system 21. The light source apparatus 3 includes a light source enclosure 31, a light source 32, an afocal optical element 33, a first phase retarder 34, a diffusively transmitting element 35, a light separator/combiner 36, a first light collector 37, a second phase retarder 38, a second light collector 39, a diffuser optical element 40, a third phase retarder 41, and a wavelength converting apparatus 5A, as shown in FIG. 2.

An optical axis Ax2, which extends linearly, and an optical axis Ax3, which is perpendicular to the optical axis Ax2 and extends linearly, are set in the light source apparatus 3. The optical axis Ax3 coincides with the optical axis Ax1 in the homogenizing system 21.

The light source 32, the afocal optical element 33, the first phase retarder 34, the diffusively transmitting element 35, the light separator/combiner 36, the second phase retarder 38, the second light collector 39, and the diffuser optical element 40 are disposed on the optical axis Ax2.

The wavelength converting apparatus 5A, the first light collector 37, the light separator/combiner 36, and the third phase retarder 41 are disposed on the optical axis Ax3.

In the following description, three directions perpendicular to one another are referred to as a +X direction, a +Y direction, and a +Z direction. It is assumed in the present embodiment that the +X direction is a direction in which the light source 32 outputs light along the optical axis Ax2, and that the +Z direction is a direction in which the light source apparatus 3 outputs the illumination light along the optical axis Ax3. Although not shown, the direction opposite the +X direction is referred to as a −X direction, the direction opposite the +Y direction is referred to as a −Y direction, and the direction opposite the +Z direction is referred to as a −Z direction.

### Configuration of Light Source Enclosure

The light source enclosure 31 houses the light source 32, the afocal optical element 33, the first phase retarder 34, the diffusively transmitting element 35, the light separator/combiner 36, the first light collector 37, the second phase retarder 38, the second light collector 39, the diffuser optical element 40, the third phase retarder 41, and the wavelength converting apparatus 5A. The light source enclosure 31 is a sealed enclosure that dust and the like is unlikely to enter.

### Configuration of Light Source

The light source 32 includes at least one solid-state light emitter 321, and the at least one solid-state light emitter 321 emits, in the +X direction, light to be incident on the diffuser optical element 40 and the wavelength converting apparatus 5A. The solid-state light emitter 321 emits blue light that is excitation light. For example, the solid-state light emitter 321 is a laser diode (LD) that emits laser light having a peak wavelength of 440 nm.

The light output by the light source 32 is s-polarized blue light BLs with respect to the light separator/combiner 36, but not necessarily. The light output by the light source 32 may be p-polarized blue light BLp with respect to the light separator/combiner 36, or may be blue light that is a mixture of s-polarized light and p-polarized light. In the latter case, the first phase retarder 34 can be omitted.

### Configuration of Afocal Optical Element

The afocal optical element 33 adjusts the luminous flux diameter of the blue light BLs incident in the +X direction from the light source 32. The afocal optical element 33 is configured with a lens 331, which collects incident light, and a lens 332, which parallelizes the luminous flux collected by the lens 331. Note that the afocal optical element 33 may be omitted.

### Configuration of First Phase Retarder

The first phase retarder 34 is provided between the lens 331 and the lens 332. The first phase retarder 34 converts part of the incident blue light BLs into the blue light BLp and outputs light containing the s-polarized blue light BLs and the p-polarized blue light BLp. The first phase retarder 34 may be rotated by a rotator around an axis of rotation along the optical axis Ax2. In this case, the ratio between the s-polarized light component and the p-polarized light component in the blue light output from the first phase retarder 34 can be adjusted in accordance with the angle of rotation of the first phase retarder 34.

### Configuration of Diffusively Transmitting Element

The diffusively transmitting element 35 homogenizes the illuminance distributions of the blue light BLp and the blue light BLs incident in the +X direction from the lens 332. The blue light BLp and the blue light BLs having passed through the diffusively transmitting element 35 is incident on the light separator/combiner 36. Examples of the diffusively transmitting element 35 may include a configuration having a hologram, a configuration in which multiple lenslets are arranged in a plane perpendicular to the optical axis, and a configuration in which a surface through which the light passes is a rough surface.

Note that the diffusively transmitting element 35 may be replaced with a homogenizer optical element including a pair of multi-lenses.

### Configuration of Light Separator/Combiner

The light separator/combiner 36 has the function as a light separator that separates incident light, and the function as a light combiner that combines two kinds of light incident in two directions.

The light separator/combiner 36 is a polarizing beam splitter and separates the s-polarized light component and the p-polarized light component contained in the incident light. Specifically, the light separator/combiner 36 reflects the s-polarized light component and transmits the p-polarized light component. The light separator/combiner 36 further has a color separation characteristic of transmitting light having a predetermined wavelength and light having wavelengths longer than the predetermined wavelength regardless of the type of polarized light component, the s-polarized light component or the p-polarized light component. Therefore, out of the blue light BLp and the blue light BLS incident on the light separator/combiner 36 from the diffusively transmitting element 35, the p-polarized blue light BLp passes through the light separator/combiner 36 in the +X direction and enters the second phase retarder 38. On the other hand, the s-polarized blue light BLs is reflected in the −Z direction off the light separator/combiner 36 and enters the first light collector 37.

Note that the light separator/combiner 36 may have the function of a half-silvered mirror that transmits part of light incident from the light source 32 via the diffusively transmitting element 35 and reflects the remainder of the light, and the function of a dichroic mirror that reflects blue light incident from the diffuser optical element 40 and transmits fluorescence incident from the wavelength converting apparatus 5A and having wavelengths longer than the wavelength of the blue light. In this case, the first phase retarder 34 can be omitted.

### Configuration of First Light Collector

The first light collector 37 constitutes a pickup system. The first light collector 37 causes the blue light BLs reflected in the −Z direction off the light separator/combiner 36 to be collected at a wavelength converter 54, which will be described later, of a phosphor wheel 52A provided in the wavelength converting apparatus 5A. The first light collector 37 parallelizes fluorescence YL incident in the +Z direction from the wavelength converter 54 and outputs the parallelized fluorescence YL to the light separator/combiner 36. In the present embodiment, the first light collector 37 is configured with three lenses 371, 372, and 373, but the number of the lenses that constitute the first light collector 37 is not limited to a specific number.

### Schematic Configuration of Wavelength Converting Apparatus

The wavelength converting apparatus 5A includes the phosphor wheel 52A, which converts the wavelength of the blue light BLs incident from the first light collector 37 and outputs the fluorescence YL. The phosphor wheel 52A is what is called a reflective wavelength converter and outputs the fluorescence YL in the direction opposite the direction in which the blue light BLs, which is the excitation light, is incident. Note that the configuration of the wavelength converting apparatus 5A will be described later in detail.

The fluorescence YL output from the wavelength converting apparatus 5A in the +Z direction is parallelized by the first light collector 37, and then incident on the light separator/combiner 36. As described above, since the light separator/combiner 36 has a characteristic of transmitting the fluorescence YL, the fluorescence YL incident on the light separator/combiner 36 along the +Z direction passes through the light separator/combiner 36 and enters the third phase retarder 41.

### Configuration of Second Phase Retarder

The second phase retarder 38 is disposed at a position shifted in the +X direction from the light separator/combiner 36. That is, the second phase retarder 38 is disposed between the light separator/combiner 36 and the second light collector 39. The second phase retarder 38 converts the blue light BLp having passed through the light separator/combiner 36 in the +X direction into circularly polarized blue light BLc. The blue light BLC having passed through the second phase retarder 38 in the +X direction enters the second light collector 39.

### Configuration of Second Light Collector

The second light collector 39 causes the blue light BLc having passed through the light separator/combiner 36 in the +X direction and incident from the second phase retarder 38 to be collected at the diffuser optical element 40. The second light collector 39 parallelizes light incident in the −X direction from the diffuser optical element 40 and outputs the parallelized light to the second phase retarder 38. In the present embodiment, the second light collector 39 is configured with three lenses 391, 392, and 393, but the number of the lenses that constitute the second light collector 39 is not limited to a specific number.

### Configuration of Diffuser Optical Element

The diffuser optical element 40 diffuses the incident blue light BLc at an angle of diffusion equal to the angle at which the fluorescence YL is output from the wavelength converting apparatus 5A. Specifically, the diffuser optical element 40 causes the blue light BLC incident in the +X direction from the second light collector 39 to be diffusively reflected in the −X direction. The diffuser optical element 40 is a reflective element that causes the incident blue light BLc to undergo Lambert reflection. Note that the diffuser optical element 40 may be rotated by a rotator around an axis of rotation parallel to the optical axis Ax2.

The blue light BLc diffused by the diffuser optical element 40 passes through the second light collector 39 and then enters the second phase retarder 38. When the blue light BLc incident on the diffuser optical element 40 is reflected off the diffuser optical element 40, the blue light BLc is converted into circularly polarized light having a rotation direction opposite the rotation direction of the incident blue light BLc. The blue light BLc incident on the second phase retarder 38 via the second light collector 39 is therefore converted into the s-polarized blue light BLs by the second phase retarder 38. The blue light BLs is then reflected in the +Z direction off the light separator/combiner 36 and enters the third phase retarder 41. That is, the light incident on the third phase retarder 41 from the light separator/combiner 36 is white light that is a mixture of the blue light BLs and the fluorescence YL.

### Configuration of Third Phase Retarder

The third phase retarder 41 is provided at a light exiting port 311 provided at a surface of the light source enclosure 31 that is the surface facing the positive end in the Z direction. The third phase retarder 41 converts the white light containing the blue light BLs and the fluorescence YL incident from the light separator/combiner 36 into white light that is a mixture of s-polarized light and p-polarized light. The thus converted white light is output as illumination light LT in the +Z direction via the light exiting port 311 and enters the homogenizing system 21 described above.

### Configuration of Wavelength Converting Apparatus

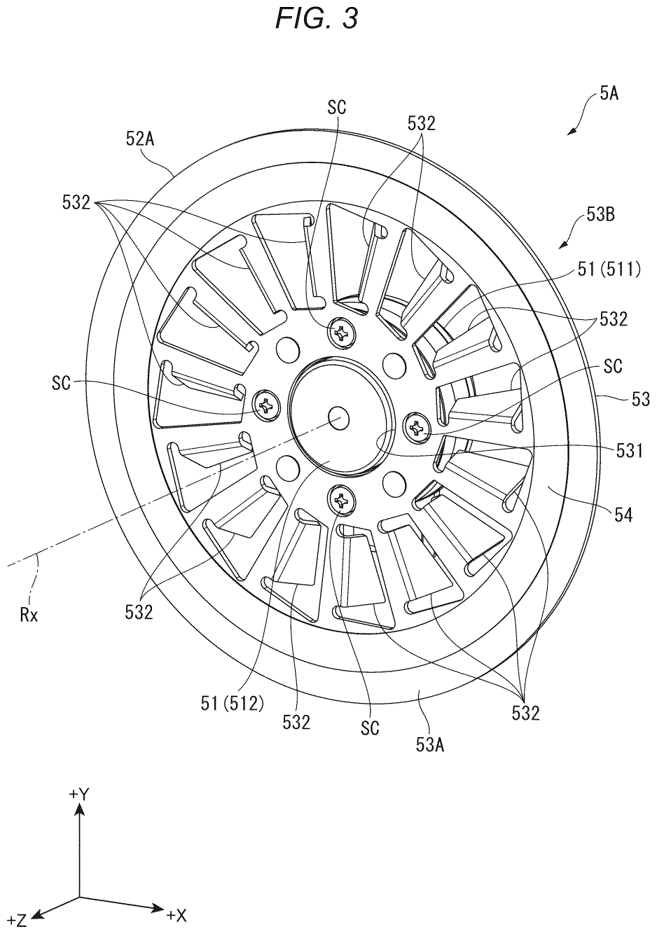

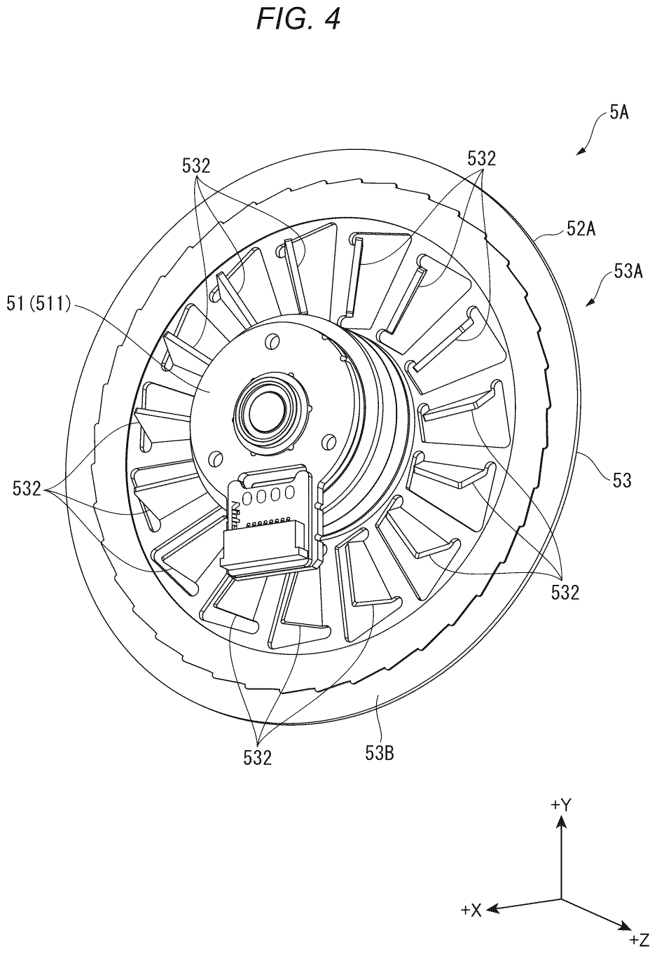

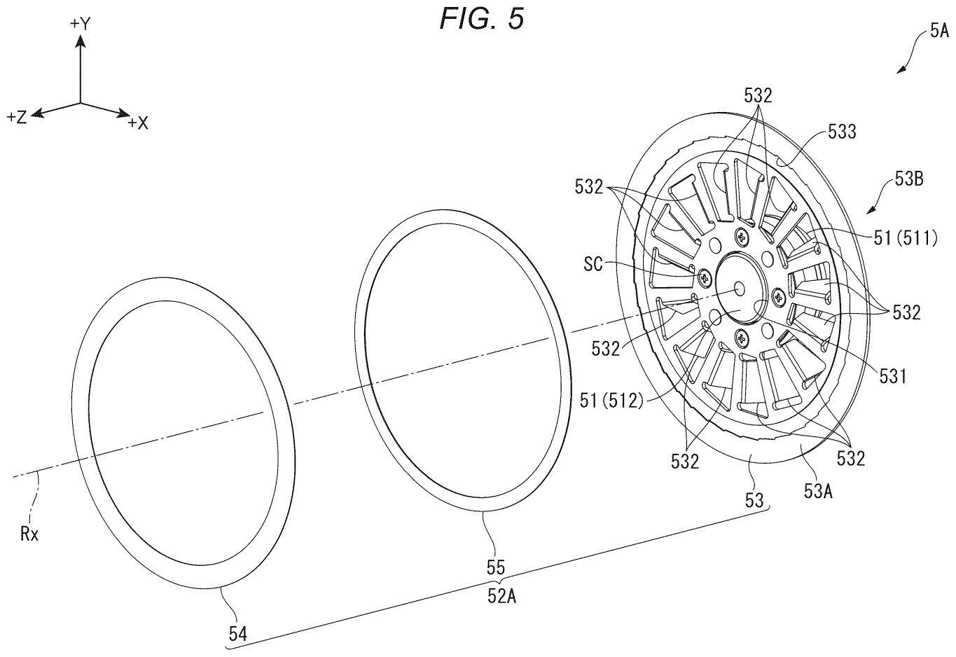

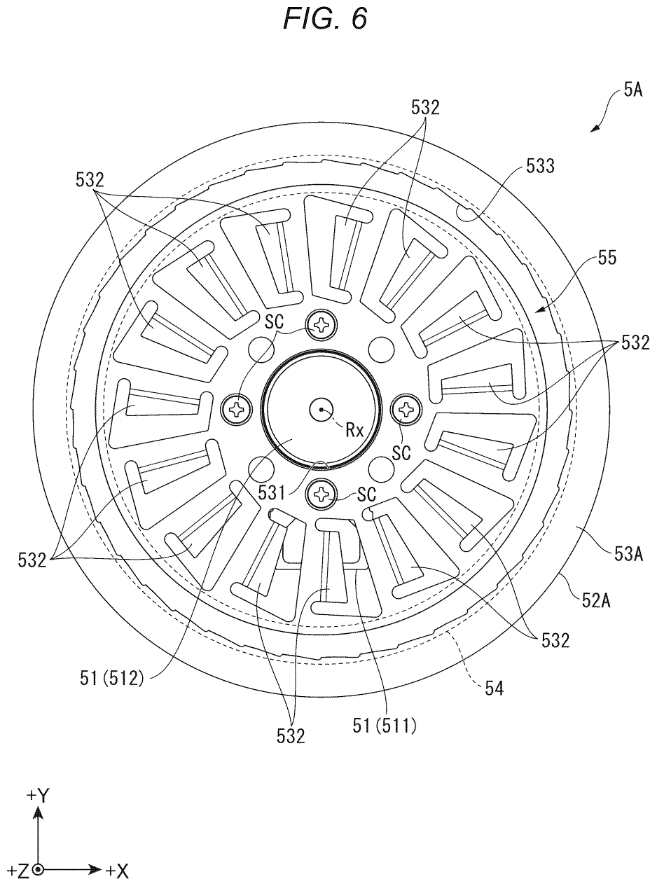

FIGS. 3 and 4 are perspective views showing the wavelength converting apparatus 5A. In detail, FIG. 3 is a perspective view showing the wavelength converting apparatus 5A viewed from the excitation light incident side, and FIG. 4 is a perspective view showing the wavelength converting apparatus 5A viewed from the side opposite the excitation light incident side. FIG. 5 is an exploded perspective view showing the wavelength converting apparatus 5A viewed from the excitation light incident side, and FIG. 6 is a front view showing the wavelength converting apparatus 5A viewed from the excitation light incident side.

The wavelength converting apparatus 5A converts first light having a first wavelength band into second light having a second wavelength band different from the first wavelength band. Specifically, the wavelength converting apparatus 5A converts the wavelength of the blue light BLS, which is the excitation light and output from the light source 32, and outputs the fluorescence YL. The wavelength converting apparatus 5A includes a rotator 51 shown in FIGS. 3 to 5, and the phosphor wheel 52A shown in FIGS. 3 to 6.

In the following description, the −Z direction is the direction in which the excitation light is incident on the wavelength converting apparatus 5A. The positive side in the Z direction is the excitation light incident side of the wavelength converting apparatus 5A, and the negative side in the Z direction is the side of the wavelength converting apparatus 5A opposite the excitation light incident side.

### Configuration of Rotator

The rotator 51 rotates the phosphor wheel 52A around an axis of rotation Rx. The rotator 51 is a motor, and a base 53 of the phosphor wheel 52A is fixed to the rotator 51 with screws SC. That is, the rotator 51 holds the base 53, and rotates the base 53 around the axis of rotation Rx.

The rotator 51 includes a rotator body 511 and a rotor 512.

The rotator body 511 rotates the rotor 512 around the axis of rotation Rx.

The rotor 512 is linked to the base 53 with the screws SC. A portion of the rotor 512 is inserted into an opening 531 provided in the base 53.

### Configuration of Phosphor Wheel

The phosphor wheel 52A is rotated by the rotator 51, converts the blue light BLs, which is the first light having the first wavelength band, into the fluorescence YL, which is the second light having the second wavelength band, and outputs the fluorescence YL. The phosphor wheel 52A includes the base 53, the wavelength converter 54, a phase changing medium 55, a metal layer 56, and a bonding layer 57.

### Configuration of Base

The base 53 is a disk made of aluminum and is rotated by the rotator 51. The base 53 has a first surface 53A facing the positive end in the Z direction, a second surface 53B provided on the side opposite the first surface 53A and facing the negative end in the Z direction, the opening 531, multiple fins 532, and a recess 533 shown in FIGS. 5 and 6.

The opening 531 is formed in a circular shape at the center of the base 53 when viewed along the axis of rotation Rx, and passes through the base 53 along the axis of rotation Rx, as shown in FIG. 3. A portion of the rotor 512 is inserted into the opening 531 in the −Z direction.

The multiple fins 532 are provided around the opening 531. The multiple fins 532 are arranged at equal intervals along the circumferential direction around the axis of rotation Rx. The multiple fins 532 are each a fin formed by cutting the base 53 and raising the cut portion in the −Z direction. When the base 53 is rotated by the rotator 51, the multiple fins 532 generate an airflow that cools the phosphor wheel 52A and dissipate the heat generated by the wavelength converter 54 and transmitted to the base 53.

The recess 533 is provided on the radially outer side of the base 53 with respect to the multiple fins 532, as shown in FIGS. 5 and 6. The recess 533 is formed in the shape of a ring around the axis of rotation Rx when viewed along the axis of rotation Rx, and is recessed in the −Z direction. The metal layer 56 is provided at the surface of the recess 533, and the phase changing medium 55 is disposed in the recess 533. The recess 533 is closed by the wavelength converter 54.

The shape of the outer circumferential edge of the recess 533 will be described later in detail.

### Configuration of Wavelength Converter

The wavelength converter 54 is formed in the shape of a ring around the axis of rotation Rx, and is disposed on a side of the base 53 that is the side facing the first surface 53A. In the present embodiment, the wavelength converter 54 is disposed at a position shifted from the base 53 in the +Z direction, and is fixed to the first surface 53A so as to close the recess 533. The dimension of the wavelength converter 54 in the radial direction defined with respect to the axis of rotation Rx is therefore greater than the dimension of the recess 533 of the base 53 in the radial direction.

The wavelength converter 54 contains a phosphor that converts the blue light BLs, which is the first light, into the fluorescence YL, which is the second light. The phosphor can, for example, be a YAG phosphor containing Ce as an activator.

### Configuration of Phase Changing Medium

The phase changing medium 55 is encapsulated in the recess 533 by the wavelength converter 54, as shown in FIGS. 5 and 6. The state of at least a portion of the phase changing medium 55 changes from a solid state to a liquid state by the heat transmitted from the wavelength converter 54. That is, the phase of at least a portion of the phase changing medium 55 changes from the solid phase to the liquid phase by the heat from the wavelength converter 54. The phase changing medium 55 is thus characterized by having a two-phase state, the liquid phase and the solid phase, at least during the period for which the blue light BLs is incident on the wavelength converter 54, and as long as the phase changing medium 55 has the two-phase state, the temperature thereof is substantially fixed even when heat is further transmitted thereto.

In the present embodiment, the phase changing medium 55 is a liquid metal having metallic luster. The liquid metal can, for example, be a low-melting-point metal such as Ga having a melting point of 29.8° C., In having a melting point of 156.4° C., and Sn having a melting point of 231.9° C., or an alloy containing multiple low-melting-point metals. When the liquid metal used as the phase changing medium 55 is an alloy containing multiple low-melting-point metals, the melting point and boiling point of the liquid metal can be adjusted by the composition and blending of the low-melting-point metals, so that the temperature range over which the two-phase state described above is maintained can be adjusted. The phase changing medium 55 in which the two-phase state of the liquid phase and the solid phase is maintained at least during the period for which the blue light BLs is incident on the wavelength converter 54 can be prepared by adjusting the blending and the proportions of the low-melting-point metals as described above. That is, the phase changing medium 55 having a substantially fixed temperature while the blue light BLs is incident on the wavelength converter 54 even when heat is transmitted from the wavelength converter 54 to the phase changing medium 55 can be prepared.

Note that the phase changing medium 55 according to the present embodiment satisfies Expression 1 below.

In Expression 1, Q is the amount of the blue light BLs incident on the wavelength converter 54 per unit period (W), and η is the efficiency at which the wavelength converter 54 converts the blue light BLS into the fluorescence YL. Note that the conversion efficiency is, for example, the amount of the output fluorescence YL/the amount of the incident blue light BLS.

In Expression 1, ΔH is the heat of fusion (J/g) of the phase changing medium 55, ρ is the specific gravity of the phase changing medium 55, and t is the depth (mm) of the recess 533. Note that the specific gravity may be the density (g/mm3).

In Expression 1, n is the number of revolutions (rpm) of the base 53 rotated by the rotator 51, d is the spot diameter (mm) of the blue light BLs incident on the wavelength converter 54, and D is the distance (mm) between the center of the spot of the blue light BLs radiated to the wavelength converter 54 and the axis of rotation Rx of the base 53. In Expression 1, π is the ratio of the circumference of a circle to the diameter thereof.

Note that the right side of Expression 1 indicates the amount of required heat of fusion per hour.

$$Q ( 1 - η ) \leq Δ H * ρ * t * n * {( d / 2 )}^{2} * {π}^{2} / 60 arctan ( d / D ) \qquad ( 1 )$$

Satisfying Expression 1 described above can prevent the phase changing medium 55, specifically, the liquid metal in the region corresponding to the spot of the blue light BLs from completely melting at the moment when the rotating phosphor wheel 52A is irradiated with the spot of the blue light BLs. The phase state of the liquid metal in the region at this point in time is the solid-liquid two-phase state.

In the period until the phase change from the solid phase to the liquid phase is completed, heat is used to change the phase state, so that the temperature of the phase changing medium 55 in the period is fixed at the melting point of the liquid metal and does not therefore rise. Therefore, during the period until the phosphor wheel 52A makes one revolution so that the same region of the wavelength converter 54 is irradiated with the spot of the blue light BLs again, the melted liquid metal is cooled by the rotation of the phosphor wheel 52A to re-solidify, so that the liquid metal repeatedly melts and solidifies, allowing the temperature of the wavelength converter 54 to be controlled to any temperature based on the melting point of the liquid metal.

The efficiency at which the phosphor contained in the wavelength converter 54 converts the blue light BLs into the fluorescence YL increases as the temperature of the wavelength converter 54 decreases, and the conversion efficiency significantly decreases when the temperature exceeds a predetermined temperature. Therefore, the situation in which satisfying Expression 1 described above allows the temperature of the wavelength converter 54 to be controlled to any temperature based on the melting point of the liquid metal during the period for which the blue light BLs is radiated is effective in the efficiency of conversion into the fluorescence YL.

Note in the present embodiment that the liquid metal constituting the phase changing medium 55 is a mixed metal that is a mixture of Ga, In, and Sn having different melting points, and changing blending of these metals as described above allows adjustment of the melting point of the liquid metal, that is, the melting point of the phase changing medium 55, and in turn adjustment of the temperature of the wavelength converter 54 during the period for which the excitation light is radiated to any value.

### Configuration of Metal Layer

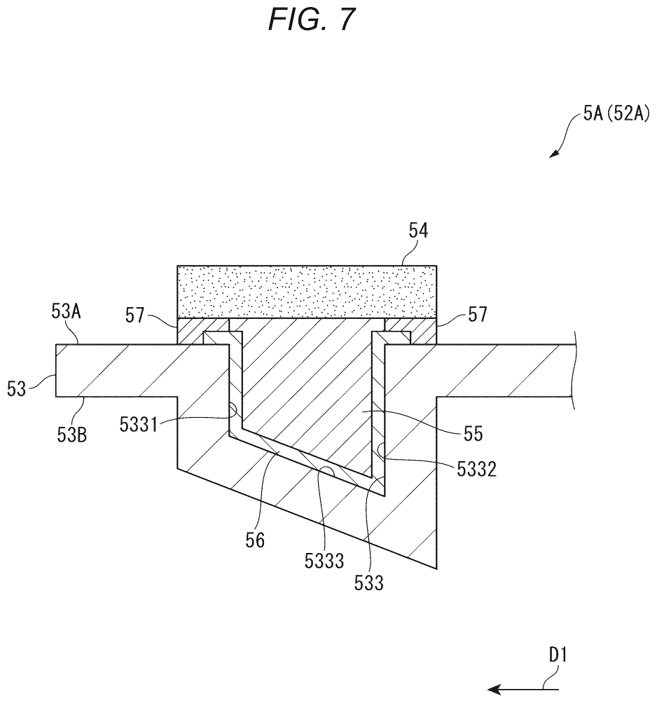

FIG. 7 shows a portion of a cross section of the phosphor wheel 52A taken along the radial direction. Note in FIG. 7 that a direction toward the radially outer side of each of the phosphor wheel 52A and the base 53 is indicated by an arrow D1.

The metal layer 56 is made of a metal other than aluminum, and is a corrosion suppressing layer that suppresses corrosion of the base 53 due to the phase changing medium 55, which is a liquid metal.

Depending on the composition of the liquid metal, the liquid metal corrodes aluminum. The phase changing medium 55 encapsulated in the recess 533 may therefore corrode the base 53 made of aluminum.

In contrast, the metal layer 56 is provided between the base 53 and the phase changing medium 55 on the side facing the first surface 53A, as shown in FIG. 7. That is, the metal layer 56 is provided at the inner surface of the recess 533 and at the first surface 53A corresponding to the circumferential edge of the recess 533. In detail, the metal layer 56 is provided at each of a first inner surface that forms an outer circumferential edge 5331 of the recess 533, a second inner surface that forms an inner circumferential edge 5332 of the recess 533, a third inner surface that forms a bottom surface 5333 of the recess 533, and at the first surface 53A corresponding to the circumferential edge of the recess 533. Therefore, even when the phase changing medium 55 is disposed in the recess 533, corrosion of the recess 533 due to the phase changing medium 55 is suppressed. Note that the wavelength converter 54, which closes the recess 533 to seal the phase changing medium 55, does not contain aluminum. Therefore, even when the phase changing medium 55 is in contact with the wavelength converter 54, corrosion of the wavelength converter 54 due to the phase changing medium is suppressed.

### Configuration of Bonding Layer

The bonding layer 57 bonds the first surface 53A and the wavelength converter 54 to each other. The bonding layer 57 is provided at the circumferential edge of the recess 533 when the first surface 53A is viewed in the +Z direction. The bonding layer 57 bonds and fixes the wavelength converter 54 to the first surface 53A, and suppresses leakage of the phase changing medium 55, which is encapsulated in the recess 533 by the wavelength converter 54, out of the recess 533.

### Configuration of Outer Circumferential Edge of Recess

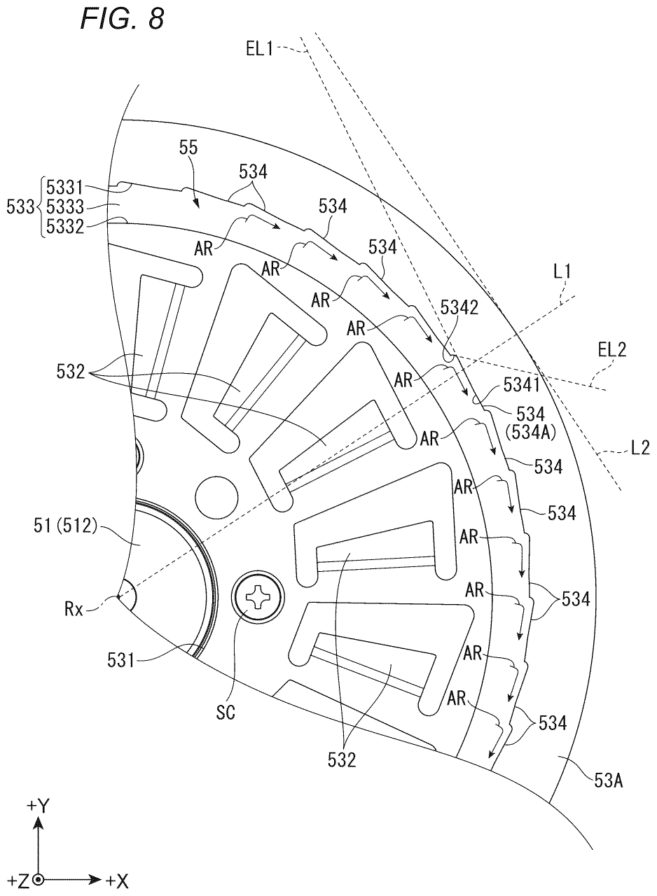

FIG. 8 is an enlarged plan view showing the recess 533 viewed in the +Z direction.

Multiple protrusions 534 arranged along the circumferential direction around the axis of rotation Rx are formed at the outer circumferential edge of the recess 533, as shown in FIG. 8. That is, the base 53 has the multiple protrusions 534, which communicate with the recess 533.

The multiple protrusions 534 are each a portion extending from the outer circumferential edge of the recess 533 in the radial direction defined with respect to the axis of rotation Rx of the base 53. The multiple protrusions 534 each have multiple inclining surfaces 5341 and 5342, which intersect with a straight line passing through the axis of rotation Rx and the protrusion 534 and extending along the radial direction of the base 53 when viewed along the axis of rotation Rx, and which each have an extension inclining with respect to a tangent at the intersection of the straight line and the outer circumferential edge of the base 53. That is, the inclining surfaces 5341 and 5342 each intersect with the radial direction of the base 53 at different angles, and the inclining surfaces 5341 and 5342 face each other and intersect with each other.

For example, when one of the multiple protrusions 534 is called a protrusion 534A, an extension EL1 of the inclining surface 5341 of the protrusion 534A intersects with a straight line L1 passing through the protrusion 534A and extending along the radial direction of the base 53, and further intersects with a tangent L2 at the intersection of the straight line L1 and the outer circumferential edge of the base 53. Similarly, an extension EL2 of the inclining surface 5342 intersects with each of the straight line L1 and the tangent L2. At the protrusion 534A, the inclining surfaces 5341 and 5342 each intersect with the radial direction of the base 53 at different angles, and the inclining surfaces 5341 and 5342 face each other and intersect with each other.

The thus configured protrusions 534 have the function of facilitating convection of the phase changing medium 55 encapsulated in the recess 533 and having the phase state changed from the solid phase to the liquid phase by the heat transmitted from the wavelength converter 54. Note that the liquid-phase phase changing medium 55 refers to the phase changing medium 55 in the liquid state.

In detail, the liquid-phase phase changing medium 55, which has fluidity, flows toward the radially outer side of the base 53 by the centrifugal force acting during the rotation of the base 53. The liquid-phase phase changing medium 55 then flows along the inclining surfaces 5341 and 5342, and returns to the radially inner side of the base 53. That is, the liquid-phase phase changing medium 55 flows in the form of convection in the recess 533 having the protrusions 534 as indicated by the arrows AR in FIG. 8. The temperature of the phase changing medium can thus be homogenized, so that the temperature of the two-phase-state phase changing medium can be readily maintained substantially fixed. In addition, causing the phase changing medium 55 to flow allows the liquid-phase phase changing medium 55 to be brought into contact with the base 53 rotated and hence cooled by a greater degree, so that the re-solidification of the liquid-phase phase changing medium 55 can be facilitated.

In addition, the phase changing medium 55 flowing in the recess 533 can suppress its concentration at the outer circumferential edge of the recess 533 due to the centrifugal force. Leakage of the phase changing medium 55 out of the recess 533 can therefore be suppressed.

### Depth of Recess

The depth of the recess 533 varies depending on the position in the recess 533, as shown in FIG. 7. Note that the depth of the recess 533 is the dimension between the first surface 53A and the bottom surface 5333 of the recess 533.

In detail, the depth of the outer-circumferential-edge-side portion of the recess 533 is smaller than the depth of the inner-circumferential edge-side portion of the recess 533. In the present embodiment, the depth of the recess 533 decreases as the bottom surface 5333 extends from the inner circumferential edge toward the outer circumferential edge of the recess 533. The configuration described above can further facilitate the convection of the liquid-phase phase changing medium during the rotation of the base 53.

### Effects of Phase Changing Medium

In the present embodiment, the phase changing medium 55 can be in contact with a surface of the wavelength converter 54 that is the surface opposite the surface on which the blue light BLs, which is the first light, is incident. A portion of the solid phase changing medium 55 melts due to the heat transmitted from the wavelength converter 54, so that the phase state of the phase changing medium 55 becomes the solid-liquid two-phase state. The temperature of the two-phase-state phase changing medium 55 is substantially fixed unless the two-phase state is eliminated, as described above. That is, in the mixed state of the solid-phase phase changing medium 55 and the liquid-phase phase changing medium 55, the temperature of the phase changing medium 55 is substantially fixed even when heat is further transmitted to the phase changing medium 55. The temperature of the wavelength converter 54 in contact with the phase changing medium 55 can therefore be maintained within a predetermined temperature range.

Since the temperature of the two-phase-state phase changing medium 55 can be defined by the composition and blending of the phase changing medium 55 as described above, the range of the temperature of the wavelength converter 54 on which the blue light BLs is incident can be defined. The temperature of the wavelength converter 54 can therefore be maintained at a temperature at which the wavelength converter 54 can maintain high light use efficiency by adjusting the composition and the blending of the phase changing medium 55 in a way that the range of the temperature of the wavelength converter 54 is a temperature range over which the efficiency at which the blue light BLs is used by the wavelength converter 54 is sufficiently high.

The phase changing medium 55, which is a liquid metal having metallic luster, reflects the light incident from the wavelength converter 54. The phase changing medium 55 therefore allows the light incident on the phase changing medium 55 from the wavelength converter 54 to return to the wavelength converter 54. Therefore, when the blue light BLs is incident on the phase changing medium 55, the wavelength converter 54 can convert the blue light BLS reflected off the phase changing medium 55 into the fluorescence YL. When the fluorescence YL enters the phase changing medium 55, the fluorescence YL reflected off the phase changing medium 55 can exit out of the wavelength converter 54. Therefore, the efficiency at which the blue light BLs is used by the wavelength converter 54 can be increased, and diffusion of the fluorescence YL output from the wavelength converter 54 can be suppressed.

### Advantages of First Embodiment

The projector 1 according to the present embodiment described above provides the advantages below.

The projector 1 includes the light source apparatus 3, the light modulators 243, which modulate the light output from the light source apparatus 3, and the projection optical apparatus 26, which projects the light modulated by the light modulators 243.

The light source apparatus 3 includes the light source 32, which outputs the blue light BLs as the first light, and the wavelength converting apparatus 5A, on which the blue light BLs output from the light source 32 is incident.

The wavelength converting apparatus 5A includes the rotator 51, the base 53, the wavelength converter 54, and the phase changing medium 55.

The base 53 has the first surface 53A, and the rotator 51 rotates the base 53.

The wavelength converter 54 is disposed on a side of the base 53 that is the side facing the first surface 53A. That is, the wavelength converter 54 is disposed on a side of the base 53 that is the side on which the blue light BLs is incident. The wavelength converter 54 converts the incident blue light BLs into the fluorescence YL. The blue light BLs corresponds to the first light having the first wavelength band, and the fluorescence YL corresponds to the second light having the second wavelength band different from the first wavelength band.

The heat of the wavelength converter 54 is transmitted to the phase changing medium 55.

The base 53 has the recess 533 provided on a side of the base 53 that is the side facing the first surface 53A at a position corresponding to the wavelength converter 54. That is, the base 53 has the recess 533 provided at the first surface 53A at a position corresponding to the wavelength converter 54.

The phase changing medium 55 is encapsulated in the recess 533, and the phase state of the phase changing medium 55 is the liquid-solid two-phase state at least during the period for which the blue light BLs is incident on the wavelength converter 54.

The temperature of the phase changing medium 55 is fixed while the two-phase state is maintained.

The temperature of the phase changing medium 55 is therefore substantially fixed at least during the period for which the blue light BLs is incident on the wavelength converter 54, so that the temperature of the wavelength converter 54 can be maintained within a predetermined range. The temperature of the wavelength converter 54 can therefore be maintained within a temperature range over which the light use efficiency of the wavelength converter 54 is sufficiently high by adjusting the composition, blending, and other factors of the phase changing medium 55 to adjust the temperature range over which the two-phase state of the phase changing medium 55 is maintained. The light use efficiency of the wavelength converter 54 can therefore be improved. In addition, since the recess 533, which encapsulates the phase changing medium 55, is provided at the position described above, the heat of the wavelength converter 54 can be readily transmitted to the phase changing medium 55.

The light source apparatus 3, which includes the wavelength converting apparatus 5A, can be configured to output light-luminance light and have high efficiency at which the blue light BLs is converted into the fluorescence YL, and the projector 1 can in turn be configured to be capable of projecting a high-luminance image.

In the wavelength converting apparatus 5A, the phase changing medium 55 is a liquid metal. The liquid metal reflects the fluorescence YL, into which the blue light BLs is converted by the wavelength converter 54, in the +Z direction. Note that the −Z direction corresponds to the direction in which the blue light BLs is incident on the wavelength converter 54, and that the +Z direction corresponds to the direction opposite the −Z direction.

According to the configuration described above, the phase changing medium 55, which is a liquid metal, can be used as a reflection layer. The configuration of the wavelength converting apparatus 5A can therefore be simplified as compared with a case where a reflection layer is separately provided.

In the wavelength converting apparatus 5A, the base 53 is made of aluminum. The base 53 includes the metal layer 56 made of a metal other than aluminum and disposed on the side facing the first surface 53A between the base 53 and the phase changing medium 55. In the present embodiment, the metal layer 56 is provided at the first surface 53A including that in the recess 533. The metal layer 56 corresponds to a corrosion suppressing layer.

When the phase changing medium 55 is a liquid metal, the phase changing medium 55 corrodes aluminum depending on the type of the liquid metal, so that there is a concern that the base 53 corrodes.

In contrast, according to the configuration described above, the metal layer 56 made of a metal other than aluminum can prevent the base 53 from corrosion due to the phase changing medium 55. The wavelength converting apparatus 5A can therefore be used in a stable manner.

In the wavelength converting apparatus 5A, the recess 533 has the multiple protrusions 534 spreading toward in the radially outer side of the base 53. The multiple protrusions 534 are provided at the outer circumferential edge 5331 of the recess 533, which is located on the radially outer side of the base 53.

When the centrifugal force acts on the phase changing medium 55 encapsulated in the recess 533 during the rotation of the base 53, the liquid-phase phase changing medium 55 tends to flow into the multiple protrusions 534 provided at the outer circumferential edge 5331 of the recess 533. Therefore, since the liquid-phase phase changing medium 55 can be likely to flow in the form of convection in the recess 533, the temperature of the entire phase changing medium 55 to which heat is transmitted can be readily homogenized, so that the temperature of the phase changing medium 55 and in turn the temperature of the wavelength converter 54 can be maintained substantially fixed. Furthermore, causing the phase changing medium 55 to flow allows the liquid-phase phase changing medium 55 to be brought into contact with the base 53 rotated and hence cooled by a greater degree, so that the re-solidification of the liquid-phase phase changing medium 55 can be facilitated.

In the wavelength converting apparatus 5A, the multiple protrusions 534 each have the multiple inclining surfaces 5341 and 5342, which intersect with the radial direction of the base 53 at different angles when viewed along the axis of rotation Rx of the base 53.

According to the configuration described above, the direction in which the liquid-phase phase changing medium 55 is moved by the centrifugal force acting on the phase changing medium 55 during the rotation of the base 53 can be changed to the directions along the inclining surfaces 5341 and 5342. Therefore, the convection of the liquid-phase phase changing medium 55 in the recess 533 can be facilitated, and concentration of the liquid-phase phase changing medium 55 at the outer circumferential edge 5331 of the recess 533 and leakage of the liquid-phase phase changing medium 55 out of the recess 533 can be avoided.

In the wavelength converting apparatus 5A, the depth of a portion of the recess 533 that is the portion facing the radially outer side of the base 53 is smaller than the depth of a portion of the recess 533 that is the portion facing the radially inner side of the base 53, as shown in FIG. 7.

The configuration described above, in which the depth of the recess 533 varies, can facilitate the flow of the liquid-phase phase changing medium 55 in the recess 533 due to the centrifugal force acting during the rotation of the base 53.

In the wavelength converting apparatus 5A, let Q be the amount of the blue light BLs incident on the wavelength converter 54 per unit period, η be the efficiency at which the wavelength converter 54 converts the blue light BLs into the fluorescence YL, ΔH be the heat of fusion of the phase changing medium 55, ρ be the specific gravity of the phase changing medium 55, t be the depth of the recess 533, d be the spot diameter of the blue light BLs incident on the wavelength converter 54, n be the number of revolutions of the base 53 rotated by the rotator 51, and D be the distance between the center of the spot of the blue light BLs radiated to the wavelength converter 54 and the axis of rotation Rx of the base 53, the phase changing medium 55 satisfies Expression 1 described above.

According to the configuration described above, during the period until the base 53 makes one revolution so that the same region of the wavelength converter 54 is irradiated with the spot of the blue light BLs again, the melted phase changing medium 55 is cooled by the rotation of the base 53 and the wavelength converter 54 to re-solidify, so that the phase changing medium is allowed to repeatedly melts and solidifies. The temperature of the wavelength converter 54 can thus be readily controlled to any temperature based on the melting point of the phase changing medium 55.

### Second Embodiment

A second embodiment of the present disclosure will next be described.

The projector according to the present embodiment is configured in the same manner as the projector 1 according to the first embodiment but differs therefrom in terms of the configuration of the phosphor wheel, which constitutes the wavelength converting apparatus. Note in the following description that the same or substantially the same portions as those having already been described have the same reference characters, and will not be described.

### Schematic Configurations of Projector and Light Source Apparatus

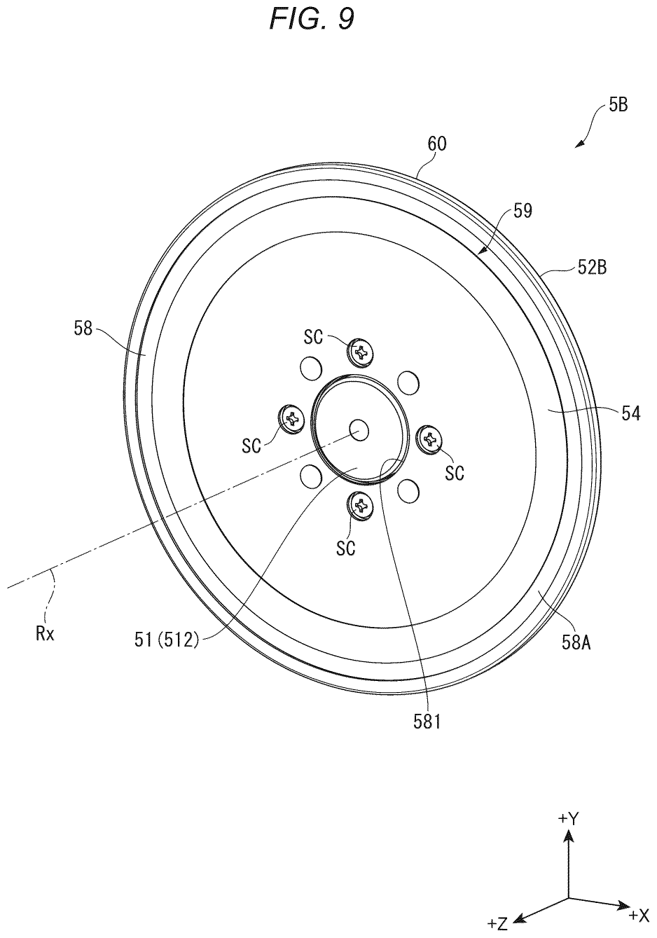

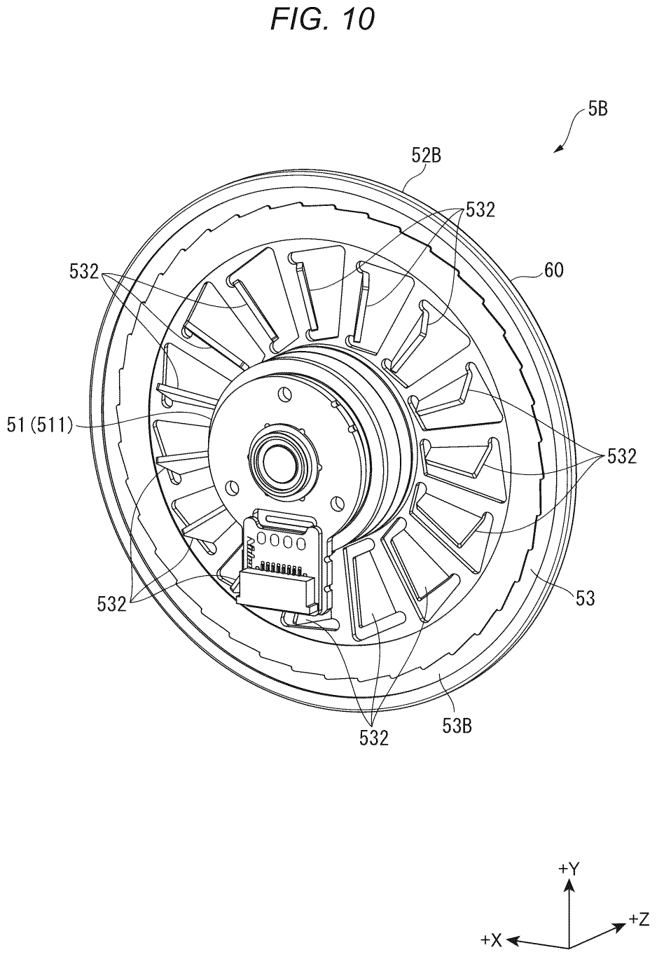

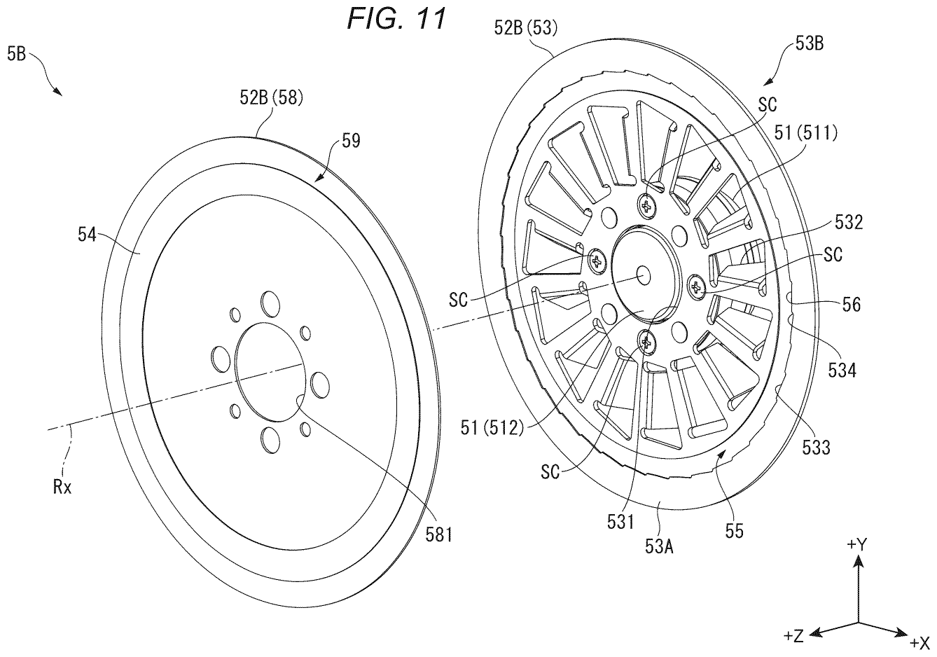

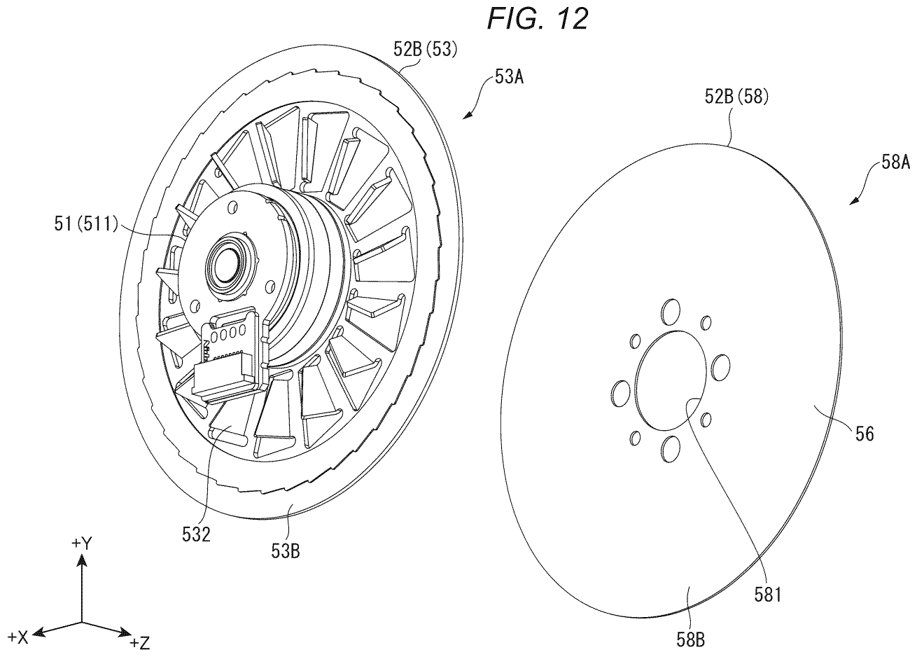

FIGS. 9 and 10 are perspective views showing a wavelength converting apparatus 5B provided in a light source apparatus of the projector according to the present embodiment. In detail, FIG. 9 is a perspective view showing the wavelength converting apparatus 5B viewed from the side on which the blue light BLs is incident, and FIG. 10 is a perspective view showing the wavelength converting apparatus 5B viewed from the side opposite the side on which the blue light BLs is incident. FIG. 11 is an exploded perspective view showing the wavelength converting apparatus 5B viewed from the side on which the blue light BLs is incident, and FIG. 12 is an exploded perspective view showing the wavelength converting apparatus 5B viewed from the side opposite the side on which the blue light BLs is incident. Note that FIGS. 11 and 12 do not show a fixing member 60.

The projector according to the present embodiment has the same components and functions as those of the projector 1 according to the first embodiment except that the wavelength converting apparatus 5A according to the first embodiment is replaced with the wavelength converting apparatus 5B shown in FIGS. 9 to 12. That is, the light source apparatus according to the present embodiment has same components and functions as those of the light source apparatus 3 according to the first embodiment except that the wavelength converting apparatus 5A is replaced with the wavelength converting apparatus 5B.

### Configuration of Wavelength Converting Apparatus

The wavelength converting apparatus 5B has the same components and functions as those of the wavelength converting apparatus 5A according to the first embodiment except that the phosphor wheel 52A according to the first embodiment is replaced with a phosphor wheel 52B. That is, the wavelength converting apparatus 5B includes the rotator 51 and the phosphor wheel 52B.

The phosphor wheel 52B is rotated by the rotator 51 around the axis of rotation Rx, converts the wavelength of the blue light BLs, and outputs the fluorescence YL, as the phosphor wheel 52A. The phosphor wheel 52B has the same components and functions as those of the phosphor wheel 52A except that a substrate 58, a reflection layer 59, and a fixing member 60 are further provided. That is, the phosphor wheel 52B includes the substrate 58, the reflection layer 59, and the fixing member 60 in addition to the base 53, the wavelength converter 54, the phase changing medium 55, the metal layer 56, and the bonding layer 57.

### Configuration of Substrate

The substrate 58 is disposed on a side of the base 53 that is the side on which the blue light BLs, which is the first light, is incident in a state in which the substrate 58 supports the wavelength converter 54, and is combined with the base 53 to encapsulate the phase changing medium 55 disposed in the recess 533 of the base 53.

The substrate 58 is a disk made of aluminum as the base 53 is, and the diameter of the substrate 58 substantially coincides with the diameter of the base 53. The substrate 58 has a first surface 58A, which faces the positive end in the Z direction and is the side on which the blue light BLs is incident, a second surface 58B facing the side opposite the first surface 58A, and an opening 581. Note that the opening 581 is provided at a position corresponding to the opening 531 when the substrate 58 is combined with the base 53, and a portion of the rotor 512 inserted through the opening 531 is inserted through the opening 581 in the −Z direction.

The wavelength converter 54 formed in the shape of a ring around the axis of rotation Rx is disposed at the first surface 58A, for example, by using an adhesive. The wavelength converter 54 is disposed at a position on the first surface 58A that is the position corresponding to the recess 533 provided at the first surface 53A of the base 53 and having the shape of a ring around the axis of rotation Rx. Note that the reflection layer 59 is provided at least in a portion of the first surface 58A that is the portion where the wavelength converter 54 is disposed.

The reflection layer 59 is provided between the wavelength converter 54 and the first surface 58A. The reflection layer 59 reflects the light incident from the wavelength converter 54 toward the wavelength converter 54, as the phase changing medium 55 in the first embodiment.

The second surface 58B is a surface facing the first surface 53A of the base 53. In the present embodiment, a metal layer 56 similar to the metal layer 56, which is the corrosion suppressing layer provided in the recess 533, is provided across the second surface 58B, as shown in FIG. 12, but not necessarily. The metal layer 56 may be provided at the second surface 58B at a position where the metal layer 56 faces the recess 533 of the base 53. That is, the metal layer 56 may be formed at the second surface 58B in the shape of a ring that covers the recess 533.

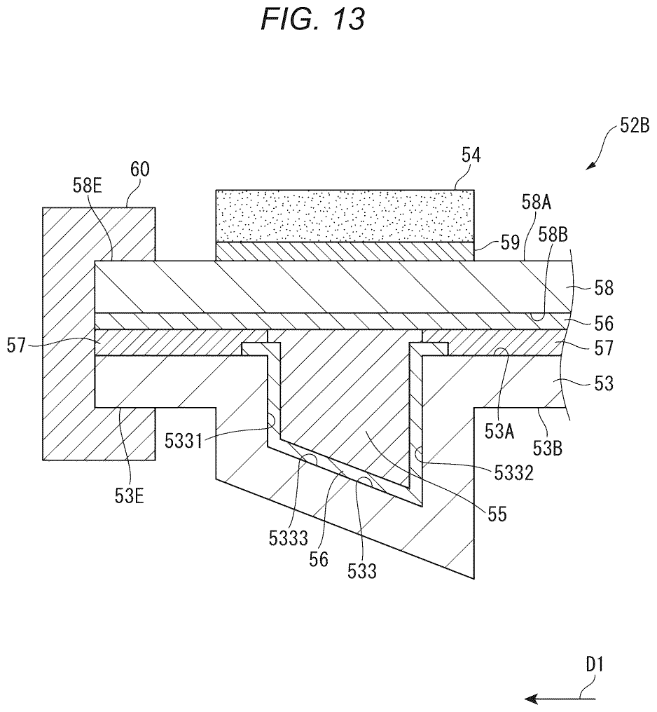

FIG. 13 diagrammatically shows a portion of a cross section taken along the radial direction of the phosphor wheel 52B. Specifically, FIG. 13 is a cross-sectional view diagrammatically showing a cross section of an end portion of the phosphor wheel 52B.

The fixing member 60 fixes the base 53 and the substrate 58 to each other by sandwiching a radially outer end portion 53E of the base 53 and a radially outer end portion 58E of the substrate 58, as shown in FIGS. 9, 10, and 13. The fixing member 60 maintains the state in which the base 53 and the substrate 58 are combined with each other, and encapsulates the phase changing medium 55 between the base 53 and the substrate 58.

The fixing member 60 is formed in the shape of a ring along the outer circumferential edge of each of the base 53 and the substrate 58, and disposed at the outer circumference of the phosphor wheel 52B to cover the gap between the base 53 and the substrate 58. The thus configured fixing member 60 prevents the phase changing medium 55 from leaking toward the radially outer side of the phosphor wheel 52B via the gap between the base 53 and the substrate 58.

### Advantages of Second Embodiment

The projector according to the present embodiment described above provides the advantages below as well as the same advantages provided by the projector 1 according to the first embodiment.

The wavelength converting apparatus 5B further includes the substrate 58 disposed on the side facing the first surface 53A of the base 53. That is, the substrate 58 is disposed on a side of the base 53 that is the side on which the blue light BLs is incident.

The substrate 58 has the first surface 58A provided with the wavelength converter 54, and the second surface 58B opposite the first surface 53A of the base 53.

According to the configuration described above, the phase changing medium 55 is encapsulated between the first surface 53A of the base 53, which is the surface provided with the recess 533, and the second surface 58B of the substrate 58, the first surface 58A of which is provided with the wavelength converter 54. The wavelength converting apparatus 5A is thus configured with the base 53 and the substrate 58 having relatively high strength combined with each other, so that the wavelength converting apparatus 5B can be readily manufactured as compared with a case where the wavelength converter 54, which has strength lower than the strength of the base 53 and the substrate 58, is attached to the first surface 53A so as to cover the recess 533. The wavelength converting apparatus 5B can therefore be more readily manufactured.

The wavelength converting apparatus 5B further includes the reflection layer 59, which is disposed between the wavelength converter 54 and the first surface 58A and reflects the fluorescence YL, into which the blue light BLs is converted by the wavelength converter 54.

According to the configuration described above, the reflection layer 59 allows the light incident on the reflection layer 59 from the wavelength converter 54 to return to the wavelength converter 54. Therefore, when the blue light BLs is incident on the reflection layer 59, the wavelength converter 54 can convert the blue light BLs reflected off the reflection layer 59 into the fluorescence YL. When the fluorescence YL is incident on the reflection layer 59, the fluorescence YL reflected off the reflection layer 59 can exit out of the wavelength converter 54. Therefore, the efficiency at which the blue light BLs is used by the wavelength converter 54 can be increased, and diffusion of the fluorescence YL output from the wavelength converter 54 can be suppressed.

In the wavelength converting apparatus 5B, the substrate 58 is made of aluminum. The substrate 58 includes the metal layer 56 provided at the second surface 58B and made of a metal other than aluminum.

As described above, when the phase changing medium 55 is a liquid metal, aluminum corrodes depending on the type of the liquid metal when the liquid metal and aluminum come into contact with each other. The base 53 may therefore corrode depending on the type of the phase changing medium 55.

In contrast, according to the configuration described above, the metal layer 56 made of a metal other than aluminum can prevent the substrate 58 from corrosion due to the phase changing medium 55. The wavelength converting apparatus 5B can therefore be used in a stable manner.

The wavelength converting apparatus 5B further includes the fixing member, which fixes the base 53 and the substrate 58 to each other by sandwiching the radially outer end portion 53E of the base 53 and the radially outer end portion 58E of the substrate 58.

The configuration described above, in which the end portions 53E and 58E are sandwiched by the fixing member 60, can prevent the phase changing medium 55 located between the base 53 and the substrate 58 from leaking out of the base 53 and the substrate 58.

### Third Embodiment

A third embodiment of the present disclosure will next be described.

A projector according to the present embodiment is configured in the same manner as the projector according to the second embodiment, but differs therefrom in the configuration of the wavelength converting apparatus. In detail, the wavelength converting apparatus according to the present embodiment differs from the projector according to the second embodiment in that the fixing member 60 is replaced with an extending portion and a bent portion. Note in the following description that the same or substantially the same portions as those having already been described have the same reference characters, and will not be described.

### Schematic Configurations of Projector and Light Source Apparatus

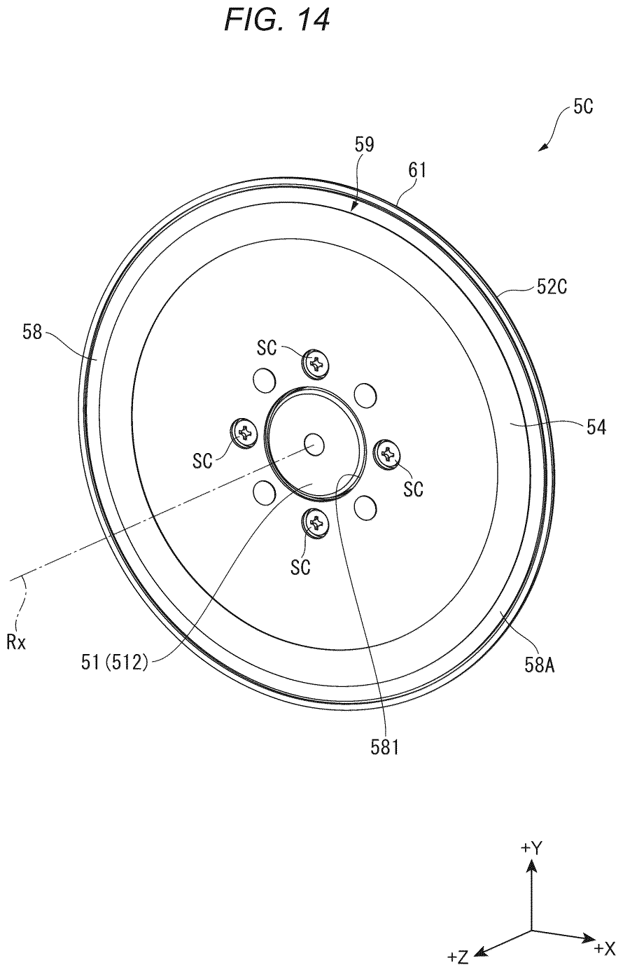

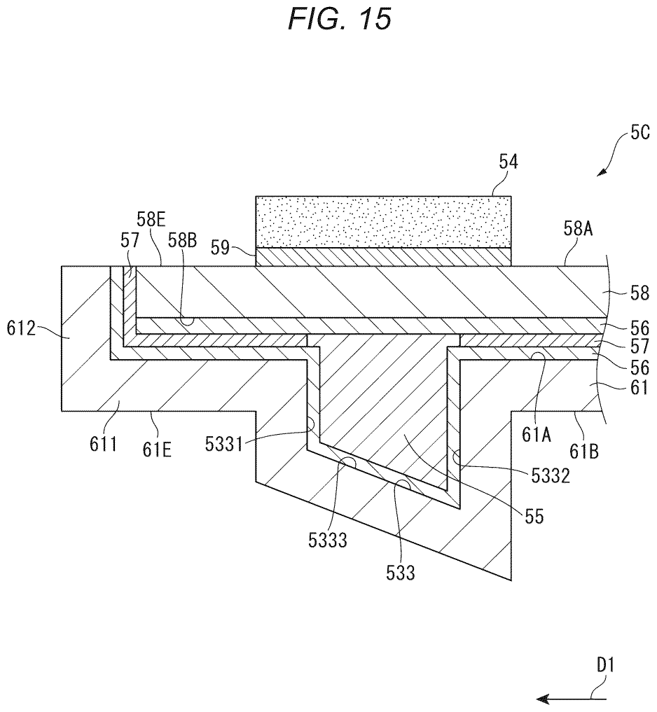

FIG. 14 is a perspective view of a wavelength converting apparatus 5C provided in a light source apparatus of the projector according to the present embodiment viewed from the side on which the blue light BLs is incident. FIG. 15 diagrammatically shows a cross section taken along the radial direction of a phosphor wheel 52C of wavelength converting apparatus 5C.

The projector according to the present embodiment has the same components and functions as those of the projector according to the second embodiment except that the wavelength converting apparatus 5B according to the second embodiment is replaced with the wavelength converting apparatus 5C shown in FIGS. 14 to 15. In other words, the projector according to the present embodiment has the same components and functions as those of the projector 1 according to the first embodiment except that the wavelength converting apparatus 5A according to the first embodiment is replaced with the wavelength converting apparatus 5C. That is, the light source apparatus according to the present embodiment has the same components and functions as those of the light source apparatus 3 according to the first embodiment except that the wavelength converting apparatus 5A is replaced with the wavelength converting apparatus 5C.

### Configuration of Wavelength Converting Apparatus

The wavelength converting apparatus 5C has the same components and functions as those of the wavelength converting apparatus 5B according to the second embodiment except that the phosphor wheel 52B according to the second embodiment is replaced with the phosphor wheel 52C. That is, the wavelength converting apparatus 5C includes the rotator 51 and the phosphor wheel 52C.

The phosphor wheel 52C is rotated by the rotator 51 around the axis of rotation Rx, converts the wavelength of the blue light BLs as the first light, and outputs the fluorescence YL as the second light, as the phosphor wheel 52B. The phosphor wheel 52C has the same components and functions as those of the phosphor wheel 52B except that the base 53 and the fixing member 60 are replaced with a base 61. That is, the phosphor wheel 52C includes the base 61, the wavelength converter 54, the phase changing medium 55, the metal layer 56, the bonding layer 57, the substrate 58, and the reflection layer 59.

### Configuration of Base

The base 61 is fixed to the rotor 512 of the rotator 51, and rotated by the rotator 51 around the axis of rotation Rx together with the substrate 58. The substrate 58 is fixed to the base 61 via the bonding layer 57 interposed between the substrate 58 and the base 61.

The base 61 has the same components and functions as those of the base 53 except that the base 61 has a first surface 61A, which faces the positive end in the Z direction, and a second surface 61B opposite the first surface 61A, and includes an extending portion 611 and a bent portion 612 at a radially outer end portion 61E, as shown in FIG. 15. That is, the base 61 includes the opening 531 and the multiple fins 532, which are not shown in FIG. 15, in addition to the first surface 61A, the second surface 61B, the recess 533, the extending portion 611, and the bent portion 612.

The extending portion 611 is a portion of the base 61 that is the portion further extending toward the radially outer side from the radially outer end portion 58E of the substrate 58. The diameter of the base 61 is therefore greater than the diameter of the substrate 58.

The bent portion 612 is a portion bent from the extending portion 611 toward the end portion 58E. That is, the bent portion 612 is a portion that forms a front end portion of the extending portion 611 and is bent in a direction toward the end portion 58E. Note that the bent portion 612 is bent by a substantially right angle with respect to the direction in which the extending portion 611 extends, but not necessarily. The bent portion 612 may incline on the side facing the substrate 58 and in a direction away from the end portion 58E as the bent portion 612 extends in the direction in which the extending portion 611 extends. The bent portion 612 may instead incline on the side facing the substrate 58 and in a direction toward the end portion 58E as the bent portion 612 extends in the direction in which the extending portion 611 extends.

Note in the wavelength converting apparatus 5C according to the present embodiment that the metal layer 56 is provided substantially across the first surface 61A of the base 61. The metal layer 56 is therefore provided not only at the inner surface of the recess 533 and the circumferential edge of the recess 533, but also at a surface of each of the extending portion 611 and the bent portion 612 that is the surface facing the substrate 58.

Unlike the fixing member 60 according to the second embodiment, the wavelength converting apparatus 5C according to the present embodiment does not have the configuration in which the base 61 and the substrate 58 are maintained facing each other. Therefore, in the wavelength converting apparatus 5C, the bonding layer 57, which is interposed between the first surface 61A of the base 61 and the second surface 58B of the substrate 58 and bonds and fixes the base 61 and the substrate 58 to each other, is provided not only at the circumferential edge of the recess 533 but also between the extending portion 611 and the substrate 58 and between the bent portion 612 and the substrate 58.

### Advantages of Third Embodiment

The projector according to the present embodiment described above provides the advantages below as well as the same advantages provided by the projector according to the second embodiment.

In the wavelength converting apparatus 5C, out of the radially outer end portion 61E of the base 61 and the radially outer end portion 58E of the substrate 58, the end portion 61E has the extending portion 611 and the bent portion 612.

The extending portion 611 extends beyond the end portion 58E toward the radially outer side of the base 61. The bent portion 612 is bent from the extending portion 611 toward the end portion 58E. That is, the bent portion 612 is bent in a way that the front end of the bent portion 612 approaches the end portion 58E. Note that the end portion 61E corresponds to a first end portion, and that the end portion 58E corresponds to a second end portion.

According to the configuration described above, even when the centrifugal force acts on the phase changing medium 55 during the rotation of the base 61 and the substrate 58, and the liquid-phase phase changing medium 55 moves toward the radially outer side of the base 61 and the substrate 58, the bent portion 612 can prevent the liquid-phase phase changing medium 55 from leaking out of the base 61 and the substrate 58.

### Fourth Embodiment

A fourth embodiment of the present disclosure will next be described.

A projector according to the present embodiment is configured in the same manner as the projector according to the second embodiment, but differs therefrom in the configuration of the wavelength converting apparatus. In detail, the wavelength converting apparatus according to the present embodiment differs from the wavelength converting apparatus according to the second embodiment in that a helical recess is provided. Note in the following description that the same or substantially the same portions as those having already been described have the same reference characters, and will not be described.

### Schematic Configurations of Projector and Light Source Apparatus

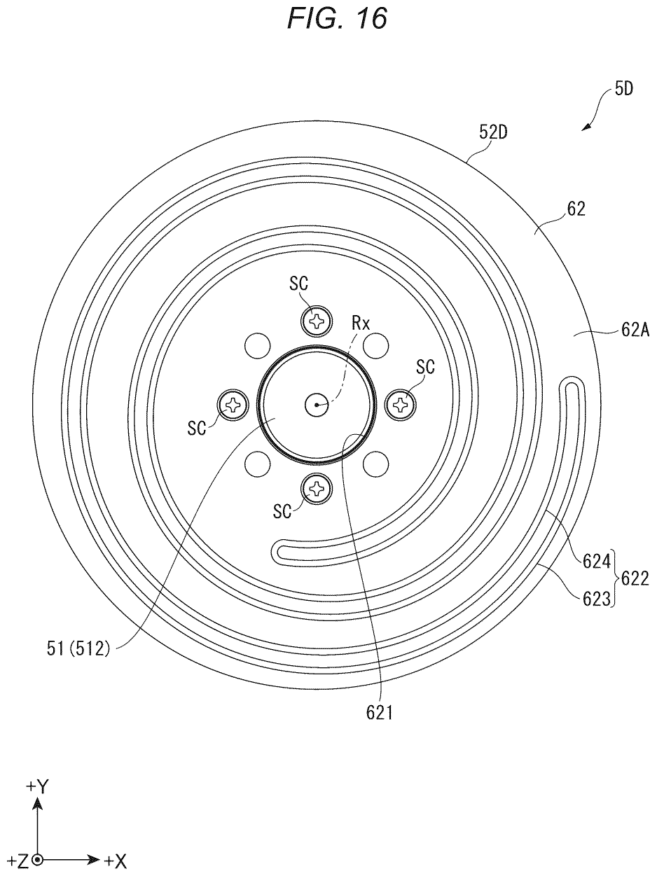

FIG. 16 is a plan view of a wavelength converting apparatus 5D provided in a light source apparatus of the projector according to the present embodiment viewed from the side on which the blue light BLs is incident. Note that FIG. 16 does not show the substrate 58.

The projector according to the present embodiment has the same components and functions as those of the projector according to the second embodiment except that the wavelength converting apparatus 5B according to the second embodiment is replaced with the wavelength converting apparatus 5D shown in FIG. 16. That is, the light source apparatus according to the present embodiment has the same components and functions as those of the light source apparatus according to the second embodiment except that the wavelength converting apparatus 5B is replaced with the wavelength converting apparatus 5D. In other words, the projector and the light source apparatus according to the present embodiment have the same components and functions as those of the projector 1 and the light source apparatus 3 according to the first embodiment except that the wavelength converting apparatus 5A according to the first embodiment is replaced with the wavelength converting apparatus 5D.

### Configuration of Wavelength Converting Apparatus

The wavelength converting apparatus 5D has the same components and functions as those of the wavelength converting apparatus 5B according to the second embodiment except that the phosphor wheel 52B according to the second embodiment is replaced with a phosphor wheel 52D. That is, the wavelength converting apparatus 5D includes the rotator 51 and the phosphor wheel 52D.

The phosphor wheel 52D is rotated by the rotator 51 around the axis of rotation Rx, converts the wavelength of the blue light BLs as the first light, and outputs the fluorescence YL as the second light, as the phosphor wheel 52B. The phosphor wheel 52D includes the same components and functions as those of the phosphor wheel 52B except that the base 53 and the fixing member 60 are replaced with a base 62. That is, the phosphor wheel 52D includes the wavelength converter 54, the phase changing medium 55, the metal layer 56, the bonding layer 57, the substrate 58, and the reflection layer 59, none of which is shown in FIG. 16 in addition to the base 62 shown in FIG. 16.

### Configuration of Base

The base 62 is fixed to the rotor 512 of the rotator 51, and is rotated by the rotator 51 around the axis of rotation Rx together with the substrate 58. The base 62 has a first surface 62A, which faces the positive end in the Z direction, and a second surface that is not shown but is located on the side opposite the first surface 62A. The substrate 58 is fixed to the base 62 via the bonding layer 57 interposed between the second surface 58B of the substrate 58 and the first surface 62A.

The base 62 has the same components and functions as those of the base 53 except that the opening 531, the multiple fins 532, and the recess 533 are replaced with an opening 621 and a recess 622. That is, the base 62 has the first surface 62A, the second surface, which is not shown, the opening 621, and the recess 622.

Note that the opening 621 is formed in a substantially circular shape at the center of the base 62 when viewed from the positive end in the Z direction, which is the side on which the blue light BLs is incident, as the opening 531 is. A portion of the rotor 512 of the rotator 51 is inserted into the opening 621 in the −Z direction.

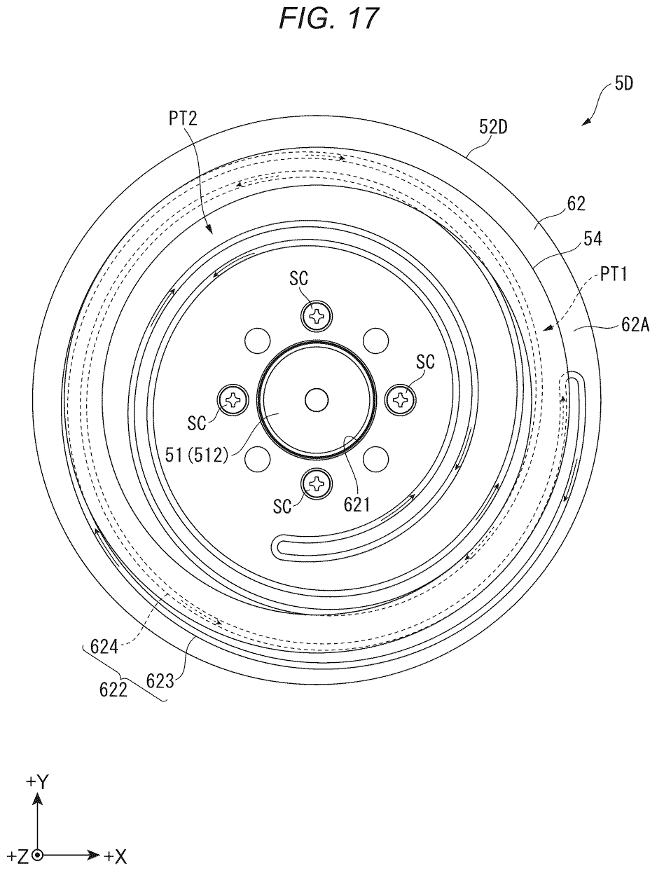

FIG. 17 shows the positional relationship between the recess 622 and the wavelength converter 54. In other words, FIG. 17 shows the wavelength converting apparatus 5D viewed in the +Z direction with the substrate 58 not shown.

The recess 622 is provided at the first surface 62A of the base 62, is recessed in the −Z direction, and is a portion in which the phase changing medium 55 is disposed, as the recess 533 according to the first to third embodiments. The recess 622 is formed in a helical shape around the axis of rotation Rx of the base 62 substantially across the first surface 62A when viewed along the axis of rotation Rx of the base 62.

The recess 622 is provided in a corresponding portion PT1 corresponding to the wavelength converter 54 and a non-corresponding portion PT2 not corresponding to the wavelength converter 54 at the first surface 62A of the base 62, as shown in FIG. 17. That is, a portion of the helical recess 622 is provided in the corresponding portion PT1, the remainder of the recess 622 is provided in the non-corresponding portion PT2, and a portion of the recess 622 that is the portion located in the corresponding portion PT1 and a portion of the recess 622 that is the portion located in the non-corresponding portion PT2 are so coupled to each other that the liquid-phase phase changing medium can flow from one to the other.

The thus configured recess 622 has a first channel 623 and a second channel 624.

The first channel 623 is a channel that causes the liquid-phase phase changing medium 55 to which the heat of the wavelength converter 54 has been transmitted by the rotation of the base 62 to flow from the corresponding portion PT1 to the non-corresponding portion PT2.

The second channel 624 is a channel that communicates with the first channel 623 and causes the liquid-phase phase changing medium 55 to flow from the non-corresponding portion PT2 to the corresponding portion PT1.

An end portion of the first channel 623 that is the end portion facing the center of the base 62 and an end portion of the second channel 624 that is the end portion facing the center of the base 62 are so coupled to each other that the liquid-phase phase changing medium 55 can flow from one to the other. Similarly, an end portion of the first channel 623 that is the end portion facing the outer edge of the base 62 and an end portion of the second channel 624 that is the end portion facing the outer edge of the base 62 are so coupled to each other that the liquid-phase phase changing medium 55 can flow from one to the other. The first channel 623 and the second channel 624 therefore constitute a circulation channel through which the liquid-phase phase changing medium 55 circulates.

### Flow of Phase Changing Medium in Recess

The heat generated in the wavelength converter 54 by the incident blue light BLs, which is the first light, is transmitted to the corresponding portion PT1 at the first surface 62A of the base 62 via the substrate 58. Accordingly, out of the phase changing medium 55 disposed in the recess 622, a portion of the solid-phase phase changing medium 55 in the recess 622 located in the corresponding portion PT1 melts and changes into the liquid-phase phase changing medium 55. The aforementioned phase change of the phase changing medium 55 gradually affects the entire phase changing medium 55 in the recess 622, and the liquid-phase phase changing medium 55 circulates through the first channel 623 and the second channel 624.

When the rotation of the base 62 causes the liquid-phase phase changing medium 55 to flow from the corresponding portion PT1 to the non-corresponding portion PT2 through the first channel 623, the heat transmitted to the phase changing medium 55 is transferred from the corresponding portion PT1 to the non-corresponding portion PT2.

When the rotation of the base 62 causes the liquid-phase phase changing medium 55 to flow from the non-corresponding portion PT2 to the corresponding portion PT1 through the second channel 624, the liquid-phase phase changing medium 55 having a relatively low temperature is present in the corresponding portion PT1.

The aforementioned circulation of the liquid-phase phase changing medium 55 allows the liquid-phase phase changing medium 55 to be used as a heat transferring medium that transfers heat from the corresponding portion PT1 to the non-corresponding portion PT2, so that a situation in which the temperature of the phase changing medium 55 becomes too high can be avoided. Therefore, the phase changing medium 55 can be readily maintained in the solid-liquid two-phase state, and the temperature of the wavelength converter 54 can in turn be readily maintained within a predetermined range.

Note in the present embodiment that it is assumed that the first channel 623 is the channel through which the liquid-phase phase changing medium 55 flows from the corresponding portion PT1 to the non-corresponding portion PT2, and that the second channel 624 is the channel through which the liquid-phase phase changing medium 55 flows from the non-corresponding portion PT2 to the corresponding portion PT1, but not necessarily. The second channel 624 may be the channel through which the liquid-phase phase changing medium 55 flows from the corresponding portion PT1 to the non-corresponding portion PT2, and the first channel 623 may be the channel through which the liquid-phase phase changing medium 55 flows from the non-corresponding portion PT2 to the corresponding portion PT1.

### Advantages of Fourth Embodiment

The projector according to the present embodiment described above provides the advantages below as well as the same advantages provided by the projector according to the second embodiment.

In the wavelength converting apparatus 5D, the recess 622 has a helical shape when viewed along the axis of rotation Rx of the base 62. The recess 622, which is provided at the base 62, is provided in the corresponding portion PT1 corresponding to the wavelength converter 54 and the non-corresponding portion PT2 not corresponding to the wavelength converter 54.

The recess 622 has the first channel 623 and the second channel 624.

The first channel 623 is the channel that causes the liquid-phase phase changing medium 55 to which the heat of the wavelength converter 54 has been transmitted by the rotation of the base 62 to move from the corresponding portion PT1 to the non-corresponding portion PT2.

The second channel 624 is the channel that communicates with the first channel 623 and causes the liquid-phase phase changing medium 55 to move from the non-corresponding portion PT2 to the corresponding portion PT1.

Note that the helical recess 622 is a single channel configured with the first channel 623 and the second channel 624 coupled to each other.

According to the configuration described above, causing the phase changing medium 55 having changed from the solid phase to the liquid phase to flow from the corresponding portion PT1 to the non-corresponding portion PT2 through the first channel 623 allows the heat of the liquid-phase phase changing medium 55 to be dissipated to the non-corresponding portion PT2 separate from the wavelength converter 54. The liquid-phase phase changing medium 55 from which the heat has been dissipated to the non-corresponding portion PT2 is then caused to flow from the non-corresponding portion PT2 to the corresponding portion PT1 through the second channel 624, so that the liquid-phase phase changing medium 55 can be circulated in the recess 622. Since the liquid-phase phase changing medium 55 can be used as the heat transferring medium, which transfers heat from the corresponding portion PT1 to the non-corresponding portion PT2, as described above, a situation in which the entire phase changing medium 55 changes to the liquid-phase phase changing medium 55 can be avoided, so that the temperature of the wavelength converter 54 located in the corresponding portion PT1 can be readily maintained within the temperature range described above.

### Variations of Embodiments

The present disclosure is not limited to any of the embodiments described above, and variations, improvements, and other modifications to the extent that the object of the present disclosure can be achieved fall within the scope of the present disclosure.

In each of the embodiments described above, it is assumed that the phase changing medium 55 is a liquid metal, but not necessarily. The phase changing medium 55 is not limited to a liquid metal and may be another substance as long as the phase changing medium can be maintained in the liquid-solid two-phase state at least during the period for which the blue light BLs is incident on the wavelength converter 54.

In the first embodiment described above, it is assumed that the phase changing medium 55 is also used as a reflection layer that reflects the light incident from the wavelength converter 54, but not necessarily. The phase changing medium 55 may not have reflection characteristics. In this case, for example, a reflection layer may be formed at a surface of the wavelength converter 54 that is the surface opposite the surface on which of the blue light BLs is incident. The reflection layer can, for example, be a reflection layer primarily containing silver.

In the embodiments described above, it is assumed that the bases 53, 61, and 62 are made of aluminum, and the metal layer 56 as a corrosion suppressing layer made of a metal other than aluminum is provided between each of the bases 53, 61, and 62 and the phase changing medium 55, but not necessarily. The bases 53, 61, and 62 may not contain aluminum and may instead be made of a metal or an alloy other than aluminum. In this case, the metal layer 56 may be omitted.

In the first to third embodiments described above, it is assumed that the recess 533 includes the multiple protrusions 534 provided at the outer circumferential edge 5331 of the recess 533, which is located on the radially outer side of the bases 53, 61, and 62, and extending toward the radially outer side of the bases 53, 61, and 62, but not necessarily. The recess 533 may not include the protrusions 534. On the other hand, the channels 623 and 624 of the recess 622 according to the fourth embodiment described above may each include multiple protrusions 534.

In the first to third embodiments described above, it is assumed that the recess 533 includes the multiple protrusions 534 each having the inclining surface 5341 and 5342, but not necessarily. The recess 533 may include multiple arcuate or corrugated protrusions in place of the multiple protrusions 534 arranged at equal intervals along the circumferential direction around the axis of rotation Rx. In this case, the multiple protrusions may be provided at the outer circumferential edge 5331 at equal intervals along the circumferential direction around the axis of rotation Rx, or may be provided at random along the circumferential direction. The same applies to the recess 622.

Furthermore, the sizes of the multiple protrusions in the circumferential direction around the axis of rotation Rx may differ from each other. The same applies to the protrusions 534.

In the first to third embodiments described above, it is assumed that the depth of a portion of the recess 533 that is the portion facing the radially outer side of the bases 53 and 61 is smaller than the depth of a portion of the recess 533 that is the portion facing the radially inner side of the bases 53 and 61. In detail, it is assumed that the depth of the recess 533 decreases as the recess 533 extends from the radially inner portion toward the radially outer portion of the bases 53 and 61, but not necessarily. The depth of the recess 533 may be fixed, or may increase as the recess 533 extends from the radially inner portion toward the radially outer portion of the bases 53 and 61. Furthermore, such a change in depth may be applied to the recess 622.

In the first to fourth embodiments described above, it is assumed that the phase changing medium 55 satisfies Expression 1 described above, but not necessarily. The phase changing medium 55 may not satisfy Expression 1 described above.

In the second and third embodiments described above, it is assumed that the substrate 58 provided on a side of the bases 53, 61, and 62 that the side on which the blue light BLs is incident and which is the side facing the first surfaces 53A, 61A, and 62A, is formed in the shape of a disk when viewed along the axis of rotation Rx, and is fixed to the bases 53, 61, and 62 via the bonding layer 57, but not necessarily. The shape of the substrate 58 can be changed as appropriate.

For example, the substrate 58 may be formed in the shape of a ring corresponding to the wavelength converter 54, may support the wavelength converter 54, and may be disposed at the bases 53 and 61 so as to cover the recess 533 in place of the wavelength converter 54 in the first embodiment. In this case, it is preferable that the substrate 58 is made of a metal other than aluminum.

In the second to fourth embodiments described above, it is assumed that the wavelength converting apparatuses 5B, 5C, and 5D each include the reflection layer 59 disposed between the wavelength converter 54 and the first surface 58A of the substrate 58, but not necessarily. The reflection layer 59 may be omitted, for example, in a case where the first surface 58A has sufficient reflection characteristics.

In the second to fourth embodiments described above, it is assumed that the metal layer 56 as the corrosion suppressing layer is provided at the second surface 58B of the substrate 58, but not necessarily. The metal layer 56 may not be provided at the second surface 58B in a case where the substrate 58 is made of a metal or an alloy other than aluminum.

In the second embodiment described above, it is assumed that the wavelength converting apparatus 5B includes the ring-shaped fixing member 60, which sandwiches the radially outer end portions 53E and 58E of the base 53 and the substrate 58, but not necessarily. The fixing member 60 may have another configuration such as a screw as long as the fixing member 60 can fix the base 53 and the substrate 58 to each other. The fixing member 60 may be omitted as long as the base 53 and the substrate 58 can be fixed to each other and leakage of the phase changing medium 55 out of the base 53 and the substrate 58 can be avoided.

In the third embodiment described above, it is assumed that the base 61 includes the extending portion 611, which is provided at the radially outer end portion 61E, and extends radially outward beyond the radially outer end portion 58E of the substrate 58, and the bent portion 612, which is bent toward the end portion 58E, but not necessarily. The substrate 58 may include an extending portion and a bent portion similar to the extending portion 611 and the bent portion 612, and the base 61 may not include the extending portion 611 or the bent portion 612.

Note that the bent portion 612 may be bent from the extending portion 611 toward the end portion 58E. That is, the bent portion 612 only needs to extend in a direction that intersects with the extending portion 611, the bent portion 612 may be formed by bending the base 61, and the base 61 may be so manufactured that the bent portion 612 is provided in advance.

In the fourth embodiment described above, it is assumed that the helical recess 622 includes the first channel 623 and the second channel 624, and the liquid-phase phase changing medium 55 circulates through the first channel 623 and the second channel 624, but not necessarily. The recess 622 only needs to be formed in a helical shape and disposed in each of the corresponding portion PT1 and the non-corresponding portion PT2, and may not necessarily include the first channel 623 or the second channel 624.

Furthermore, the recess 622 may not have a helical shape, and multiple recesses 622 may be provided radially with respect to the axis of rotation Rx. In this case, the radially extending recesses 622 may each include the first channel 623 and the second channel 624.

In the embodiments described above, it is assumed that the first light is the blue light BLs, and that the second light is unpolarized light containing a green light component and a red light component, but not necessarily. The first light may be light having a wavelength band and a polarization state different from those of the blue light BLs, and the same applies to the second light.

In the second to fourth embodiments described above, it is assumed that the phase changing medium 55 is disposed in the recesses 533 and 622 of the bases 53, 61, and 62, but not necessarily. The bases 53, 61, and 62 may not be provided with the recess 533 or 622. In this case, the phase changing medium 55 may be encapsulated between each of the bases 53, 61, and 62 and the substrate 58.

In the embodiments described above, it is assumed that the projector includes the three light modulators 243R, 243G, and 243B, but not necessarily. The present disclosure is also applicable to a projector including two or fewer light modulators, or four or more light modulators.

In each of the embodiments described above, a transmissive liquid crystal panel having a light incident surface and a light exiting surface different from each other is presented by way of example as each of the light modulators 243, and a reflective liquid crystal panel having a single surface serving both as the light incident surface and a light exiting surface may be employed. Furthermore, a light modulator using any element other than a liquid-crystal-based element, such as a device using micromirrors, for example, a digital micromirror device (DMD), may be employed as long as the element is capable of modulating an incident luminous flux to form an image according to image information.

The aforementioned embodiments of the present disclosure have been described with reference to the case where the light source apparatus is used in a projector, but not necessarily. The light source apparatus according to any of the embodiments of the present disclosure may be employed in an electronic instrument other than a projector, such as a lighting fixture and a headlight of an automobile.

### SUMMARY OF PRESENT DISCLOSURE

The present disclosure is summarized below as additional remarks.

### Additional Remark 1

A wavelength converting apparatus including:
a base having a first surface;
a rotator configured to rotate the base;
a wavelength converter disposed at a side facing the first surface of the base and configured to convert incident first light having a first wavelength band into second light having a second wavelength band different from the first wavelength band; and
a phase changing medium to which heat of the wavelength converter is transmitted,
wherein the base has a recess provided at the first surface of the base at a position corresponding to the wavelength converter,
the phase changing medium is encapsulated in the recess, and
a phase state of the phase changing medium is a liquid-solid two-phase state at least during a period for which the first light is incident on the wavelength converter.

The temperature of the phase changing medium is fixed while the two-phase state is maintained.

The temperature of the phase changing medium is therefore substantially fixed at least during the period for which the first light is incident on the wavelength converter, so that the temperature of the wavelength converter can be maintained within a predetermined range. The temperature of the wavelength converter can therefore be maintained within a temperature range over which the light use efficiency of the wavelength converter is sufficiently high by adjusting the composition, blending, and other factors of the phase changing medium to adjust the temperature range over which the two-phase state of the phase changing medium is maintained. The light use efficiency of the wavelength converter can therefore be improved. In addition, since the recess, which encapsulates the phase changing medium, is provided at the position described above, the heat of the wavelength converter can be readily transmitted to the phase changing medium.

### Additional Remark 2

In the wavelength converting apparatus according to Additional Remark 1,
the phase changing medium is a liquid metal, and
the liquid metal is configured to reflect the second light, into which the first light is converted by the wavelength converter, in a direction opposite a direction in which the first light is incident on the wavelength converter.

According to the configuration described above, the phase changing medium, which is a liquid metal, can be used as a reflection layer. The configuration of the wavelength converting apparatus can therefore be simplified as compared with a case where a reflection layer is separately provided.

### Additional Remark 3

In the wavelength converting apparatus according to Additional Remark 1 or 2,
the base is made of aluminum, and
the base includes a corrosion suppressing layer disposed on a side facing the first surface between the base and the phase changing medium, and made of a metal other than aluminum.

When the phase changing medium is a liquid metal, the phase changing medium corrodes aluminum depending on the type of the liquid metal, so that there is a concern that the base corrodes.

In contrast, according to the configuration described above, the corrosion suppressing layer made of a metal other than aluminum can prevent the base from corrosion due to the phase changing medium. The wavelength converting apparatus can therefore be used in a stable manner.

### Additional Remark 4

In the wavelength converting apparatus according to any one of Additional Remarks 1 to 3,
the recess includes multiple protrusions provided at an outer circumferential edge of the recess that is located on a radially outer side of the base, the multiple protrusions extending toward the radially outer side of the base.

When centrifugal force acts on the phase changing medium encapsulated in the recess during the rotation of the base, the liquid-phase phase changing medium tends to flow into the multiple protrusions provided at the outer circumferential edge of the recess. Therefore, since the liquid-phase phase changing medium can be likely to flow in the form of convection in the recess, the temperature of the entire phase changing medium to which heat is transmitted can be readily homogenized, so that the temperature of the phase changing medium and in turn the temperature of the wavelength converter can be maintained substantially fixed. In addition, causing the phase changing medium to flow allows the liquid-phase phase changing medium to be brought into contact with the rotated and cooled base by a greater amount, so that the re-solidification of the liquid-phase phase changing medium can be facilitated.

### Additional Remark 5

In the wavelength converting apparatus according to Additional Remark 4,
the multiple protrusions each have multiple inclining surfaces that intersect with the radial direction of the base at different angles when viewed along an axis of rotation of the base.

According to the configuration described above, the direction in which the liquid-phase phase changing medium is moved by the centrifugal force acting on the phase changing medium during the rotation of the base can be changed to the directions along the inclining surfaces. Therefore, the convection of the liquid-phase phase changing medium in the recess can be facilitated, and concentration of the liquid-phase phase changing medium at the outer circumferential edge of the recess and leakage of the liquid-phase phase changing medium out of the recess can be avoided.

### Additional Remark 6

In the wavelength converting apparatus according to any one of Additional Remarks 1 to 5,
a depth of a portion of the recess that is a portion facing a radially outer side of the base is smaller than a depth of a portion of the recess that is a portion facing a radially inner side of the base.

The configuration described above, in which the depth of the recess varies, can facilitate the movement of the liquid-phase phase changing medium in the recess due to the centrifugal force acting on the phase changing medium during the rotation of the base.

### Additional Remark 7

In the wavelength converting apparatus according to any one of Additional Remarks 1 to 6,
let Q be an amount of the first light incident on the wavelength converter per unit period, η be efficiency at which the wavelength converter converts the first light into the second light, ΔH be heat of fusion of the phase changing medium, ρ be specific gravity of the phase changing medium, t be a depth of the recess, n be a number of revolutions of the base rotated by the rotator, d be a spot diameter of the first light incident on the wavelength converter, and D be a distance between a center of the spot of the first light radiated to the wavelength converter and an axis of rotation of the base, the phase changing medium satisfies Expression 2 below.

$$Q ( 1 - η ) \leq Δ H * ρ * t * n * {( d / 2 )}^{2} * {π}^{2} / 60 arctan ( d / D ) \qquad ( 2 )$$

According to the configuration described above, during the period until the base makes one revolution so that the same region of the wavelength converter is irradiated with the first light again, the melted phase changing medium is cooled by the rotation of the base and the wavelength converter to re-solidify, so that the phase changing medium is allowed to repeatedly melts and solidifies. The temperature of the wavelength converter can thus be readily controlled to any temperature based on the melting point of the phase changing medium.

### Additional Remark 8

The wavelength converting apparatus according to any one of Additional Remarks 1 to 7, further including
a substrate disposed on the side facing the first surface of the base, and
the substrate has
a first surface provided with the wavelength converter, and
a second surface facing the first surface of the base.

According to the configuration described above, the phase changing medium is encapsulated between the first surface of the base, which is the surface provided with the recess, and the second surface of the substrate, the first surface of which is provided with the wavelength converter. The wavelength converting apparatus is thus configured with the base and the substrate having relatively high strength combined with each other, so that the wavelength converting apparatus can be readily manufactured as compared with a case where the wavelength converter, which has strength lower than the strength of the base and the substrate, is attached to the first surface so as to cover the recess. The wavelength converting apparatus can therefore be more readily manufactured.

### Additional Remark 9

The wavelength converting apparatus according to Additional Remark 8, further including
a reflection layer disposed between the wavelength converter and the first surface and configured to reflect the second light, into which the first light is converted by the wavelength converter.

According to the configuration described above, the reflection layer allows the light incident on the reflection layer from the wavelength converter to return to the wavelength converter. Therefore, when the first light is incident on the reflection layer, the wavelength converter can convert the first light reflected off the reflection layer into the second light. When the second light is incident on the reflection layer, the second light reflected off the reflection layer can exit out of the wavelength converter. Therefore, the efficiency at which the first light is used by the wavelength converter can be increased, and diffusion of the second light output from the wavelength converter can be suppressed.

### Additional Remark 10

In the wavelength converting apparatus according to Additional Remark 8 or 9,
the substrate is made of aluminum, and
the substrate includes a metal layer provided at the second surface and made of a metal other than aluminum.

As described above, when the phase changing medium is a liquid metal, aluminum corrodes depending on the type of the liquid metal when the liquid metal and aluminum come into contact with each other. The base may therefore corrode depending on the type of the phase changing medium.

In contrast, according to the configuration described above, the metal layer made of a metal other than aluminum can prevent the substrate from corrosion due to the phase changing medium. The wavelength converting apparatus can therefore be used in a stable manner.

### Additional Remark 11

The wavelength converting apparatus according to any one of Additional Remarks 8 to 10, further including
a fixing member configured to fix the base and the substrate to each other by sandwiching a radially outer end portion of the base and a radially outer end portion of the substrate.

The configuration described above, in which the radially outer end portion of the base and the radially outer end portion of the substrate are sandwiched by the fixing member, can prevent the phase changing medium located between the base and the substrate from leaking out of the base and the substrate.

### Additional Remark 12

In the wavelength converting apparatus according to any one of Additional Remarks 8 to 10,
out of a first radially outer end portion of the base and a second radially outer end portion of the substrate, one of the end portions includes
an extending portion extending radially outward beyond the other end portion, and
a bent portion bent from the extending portion toward the other end portion.

According to the configuration described above, even when the centrifugal force acts on the phase changing medium during the rotation of the base and the substrate, and the liquid-phase phase changing medium moves toward the radially outer side of the base and the substrate, the bent portion can prevent the liquid-phase phase changing medium from leaking out of the base and the substrate.

### Additional Remark 13

In the wavelength converting apparatus according to any one of Additional Remarks 8 to 12,
the recess has a helical shape when viewed along an axis of rotation of the base, and the recess that is provided at the base is provided in a corresponding portion corresponding to the wavelength converter and a non-corresponding portion not corresponding to the wavelength converter, and
the recess includes
a first channel configured to cause the phase changing medium to which heat of the wavelength converter is transmitted by rotation of the base to flow from the corresponding portion to the non-corresponding portion, and
a second channel that communicates with the first channel and is configured to cause the phase changing medium to flow from the non-corresponding portion to the corresponding portion.

According to the configuration described above, causing the phase changing medium having changed to the liquid phase to move from the corresponding portion to the non-corresponding portion through the first channel allows the heat of the liquid-phase phase changing medium to be dissipated to the non-corresponding portion separate from the wavelength converter. The liquid-phase phase changing medium is then caused to move from the non-corresponding portion to the corresponding portion through the second channel, so that the liquid-phase phase changing medium can be circulated in the recess. Since the liquid-phase phase changing medium can be used as a heat transferring medium that transfers heat from the corresponding portion to the non-corresponding portion, as described above, a situation in which the entire phase changing medium changes to the liquid-phase phase changing medium can be avoided, so that the temperature of the wavelength converter located in the corresponding portion can be readily maintained within the temperature range described above.

### Additional Remark 14

A light source apparatus including:
a light source configured to output the first light; and
the wavelength converting apparatus according to any one of Additional Remarks 1 to 13 on which the first light output from the light source is incident.

The thus configured light source apparatus can provide the same advantages as those provided by the wavelength converting apparatus described above. A light source apparatus that outputs high-luminance light and converts the first light into the second light at high efficiency can thus be configured.

### Additional Remark 15

A projector including:
a light source apparatus according to Additional Remark 14;
a light modulator configured to modulate light output from the light source apparatus; and
a projection optical apparatus configured to project the light modulated by the light modulator.

The thus configured projector can provide the same advantages as those provided by the light source apparatus described above. A projector capable of projecting a high-luminance image can thus be configured.

What is claimed is:

1. A wavelength converting apparatus comprising:
a base having a first surface;
a rotator configured to rotate the base;
a wavelength converter disposed at a side facing the first surface of the base and configured to convert incident first light having a first wavelength band into second light having a second wavelength band different from the first wavelength band; and
a phase changing medium to which heat of the wavelength converter is transmitted,
wherein the base has a recess provided at the first surface of the base at a position corresponding to the wavelength converter,
the phase changing medium is encapsulated in the recess, and
a phase state of the phase changing medium is a liquid-solid two-phase state at least during a period for which the first light is incident on the wavelength converter.

2. The wavelength converting apparatus according to claim 1, wherein
the phase changing medium is a liquid metal, and
the liquid metal is configured to reflect the second light, into which the first light is converted by the wavelength converter, in a direction opposite a direction in which the first light is incident on the wavelength converter.

3. The wavelength converting apparatus according to claim 1, wherein
the base is made of aluminum, and
the base includes a corrosion suppressing layer disposed on a side facing the first surface between the base and the phase changing medium, and made of a metal other than aluminum.

4. The wavelength converting apparatus according to claim 1, wherein
the recess includes multiple protrusions provided at an outer circumferential edge of the recess that is located on a radially outer side of the base, the multiple protrusions extending toward the radially outer side of the base.

5. The wavelength converting apparatus according to claim 4, wherein
the multiple protrusions each have multiple inclining surfaces that intersect with the radial direction of the base at different angles when viewed along an axis of rotation of the base.

6. The wavelength converting apparatus according to claim 1, wherein
a depth of a portion of the recess that is a portion facing a radially outer side of the base is smaller than a depth of a portion of the recess that is a portion facing a radially inner side of the base.

7. The wavelength converting apparatus according to claim 1, wherein
let Q be an amount of the first light incident on the wavelength converter per unit period, η be efficiency at which the wavelength converter converts the first light into the second light, ΔH be heat of fusion of the phase changing medium, ρ be specific gravity of the phase changing medium, t be a depth of the recess, n be a number of revolutions of the base rotated by the rotator, d be a spot diameter of the first light incident on the wavelength converter, and D be a distance between a center of the spot of the first light radiated to the wavelength converter and an axis of rotation of the base, the phase changing medium satisfies Expression 1 below.
$$Q ( 1 - η ) \leq Δ H * ρ * t * n * {( d / 2 )}^{2} * {π}^{2} / 60 arctan ( d / D ) \qquad ( 1 )$$

8. The wavelength converting apparatus according to claim 1, further comprising
a substrate disposed on the side facing the first surface of the base,
wherein the substrate has
a first surface provided with the wavelength converter, and
a second surface facing the first surface of the base.

9. The wavelength converting apparatus according to claim 8, further comprising
a reflection layer disposed between the wavelength converter and the first surface and configured to reflect the second light, into which the first light is converted by the wavelength converter.

10. The wavelength converting apparatus according to claim 8, wherein
the substrate is made of aluminum, and
the substrate includes a metal layer provided at the second surface and made of a metal other than aluminum.

11. The wavelength converting apparatus according to claim 8, further comprising
a fixing member configured to fix the base and the substrate to each other by sandwiching a radially outer end portion of the base and a radially outer end portion of the substrate.

12. The wavelength converting apparatus according to claim 8, wherein
out of a first radially outer end portion of the base and a second radially outer end portion of the substrate, one of the end portions includes
an extending portion extending radially outward beyond the other end portion, and
a bent portion bent from the extending portion toward the other end portion.

13. The wavelength converting apparatus according to claim 8, wherein
the recess has a helical shape when viewed along an axis of rotation of the base, and the recess that is provided at the base is provided in a corresponding portion corresponding to the wavelength converter and a non-corresponding portion not corresponding to the wavelength converter, and
the recess includes
a first channel configured to cause the phase changing medium to which heat of the wavelength converter is transmitted by rotation of the base to flow from the corresponding portion to the non-corresponding portion, and
a second channel that communicates with the first channel and is configured to cause the phase changing medium to flow from the non-corresponding portion to the corresponding portion.

14. A light source apparatus comprising:
a light source configured to output the first light; and
the wavelength converting apparatus according to claim 1 on which the first light output from the light source is incident.

15. A projector comprising:
a light source apparatus according to claim 14;
a light modulator configured to modulate light output from the light source apparatus; and
a projection optical apparatus configured to project the light modulated by the light modulator.
